(19) United States
(12) Patent Application Publication
(10) Pub. No.: US 2019/0139102 A1
(43) Pub. Date: May 9, 2019

(54) INTEGRATED RELATIONAL FITNESS DEVELOPMENT AND FUNDRAISING

(71) Applicant: MyTaj, LLC, Littleton, CO (US)

(72) Inventors: Stephen Huff, Golden, CO (US); Andrew Bennetts, Cortez, CO (US); Tamara Williams, Dolan Springs, AZ (US); Kathryn Bell, Manitou Springs, CO (US); Ned Nixon, Lakewood, CO (US); Eric Epstein, Arvada, CO (US); James Rice, Williamsburg, VA (US); Donna Rice, Willaimsburg, VA (US); Peter Girard, Golden, CO (US); Heather Hooton, Holladay, UT (US); Madeline Tyo, Louisville, CO (US); Juli Dimos, Denver, CO (US)

(21) Appl. No.: 16/145,087

(22) Filed: Sep. 27, 2018

Related U.S. Application Data
(60) Provisional application No. 62/573,599, filed on Oct. 17, 2017.
(60) Provisional application No. 62/575,826, filed on Oct. 23, 2017.
(60) Provisional application No. 62/670,142, filed on May 11, 2018.

(51) Int. Cl. G06Q 30/02; G06Q 50/00; G06Q 20/10

(52) U.S. Cl. CPC G06Q 30/0279; G06F 3/0484; G06Q 20/10; G06Q 50/01

(57) ABSTRACT

Systems and methods are provided for practicing Relational Fitness abilities. A relational fitness development and fundraising tool includes a server having a processor and a memory, a storage system in communication with the processor and storing challenge activity information, and a collaboration, reporting, and payment application stored in the memory and including a graphical user interface (GUI) module and a rule module. The processor executes the GUI and rule modules to selectively operate the application in a daily challenge mode, a training mode, a tournament mode, and a fundraising mode, where all of the operational modes involve user athletes completing relational fitness challenge activities in exchange for points and/or for fundraising dollars on behalf of a beneficiary. Other embodiments are also disclosed.

### REFERENCE TO PENDING PRIOR PATENT APPLICATIONS

This application claims the benefit under 35 U.S.C. 119(e) of U.S. Provisional Patent Application Nos. 62/573,599, filed Oct. 17, 2017 by Stephen Huff, Andrew Bennetts, Tamara Williams, Kathryn Bell, Ned Nixon, Eric Epstein, James Rice, Donna Rice, Peter Girard, Heather Hooton, Madeline Tyo, and Juli Dimos for “SYSTEMS AND METHODS FOR FACILITATING PERSONAL CONNECTIONS,” 62/575,826, filed Oct. 23, 2017 by Stephen Huff, Andrew Bennetts, Tamara Williams, Kathryn Bell, Ned Nixon, Eric Epstein, James Rice, Donna Rice, Peter Girard, Heather Hooton, Madeline Tyo, and Juli Dimos for “MOBILE CONNECTION-FACILITATION SYSTEM AND METHODS,” and 62/670,142, filed May 11, 2018 by Stephen Huff, Andrew Bennetts, Tamara Williams, Kathryn Bell, Ned Nixon, Eric Epstein, James Rice, Donna Rice, Peter Girard, Heather Hooton, Madeline Tyo, and Juli Dimos for “RELATIONAL FITNESS DEVELOPMENT SYSTEM AND METHODS OF USE,” all of which patent applications are hereby incorporated herein by reference.

### BACKGROUND

Generally, there are many things humans do in life on purpose. Any skill we learn for the first time—to drive, a new language, to juggle, to play poker, to play a sport, to improve our Fantasy Football skills—we do on purpose, with focus, attention, and planning. But when it comes to one of the most basic skills of life—how we “do relationships” or how we think, speak, and act day in and day out—we often act without awareness. Indeed, how we “do relationships” is oftentimes carried out with less focus, attention, and planning than we use to breathe. Thus, relationships with ourselves, others, and the world occur on autopilot, where we are thinking, speaking, and acting largely out of habit, routine, and/or by accident.

When life is going well—no major problems, few conflicts, good friends, good times—we fail to notice how unaware we are of our habits and routines of thinking, speaking, and acting. We don't question whether our thoughts, statements, and actions are, or are not, working for us and those around us and whether they are maximizing our wellness and fulfillment.

When life is not going as well, people oftentimes seek to improve themselves through self-improvement books, training, study, counseling, and/or other steps. There are existing electronic tools that “gamify” one or more self-improvement activities that users tend to perform in real life. However, these types of tools focus on concepts such as weight loss/nutrition (e.g., MyFitnessPal, YAZIO, etc.) and physical fitness (e.g., FitBit, Pocket Yoga, etc.), or are skills-based such as applications directed toward language learning (e.g., Duolingo, HelloTalk, etc.). Other tools address mental wellness improvement or focus. Examples include Headspace (for meditation), SuperBetter (for overall health and recovery from brain injury), and Togethr (for improving romantic relationships).

There are also existing digital tests designed to explore and/or define one's personality to inject understanding and context into one's (oftentimes subconscious) behavioral patterns and/or tendencies. Examples include Emergenetics, Strengthfinder, Stand-Out TMBC, 16 Personalities, Insights, Kolbe A, DISC Leadership Assessment, and Enneagram. These types of personality profiling tools generally involve answering a series of questions and ultimately being categorized according to personality type based upon the answers. While these types of tests provide a baseline or a framework of understanding for use in crafting more purposeful behaviors and interactions, they present a number of challenges in that they are individualistic and one-dimensional. The tools are limited to questions presented to an individual followed by resulting profiles presented by the tool. They do not incorporate a sense of discovery through action that both invites continued participation and encourages the reveal, and ultimate improvement, of one's true nature.

Beyond the existing technologies surrounding self-improvement and personality assessment, a number of existing technological platforms facilitate fundraising campaigns that are or may be linked to personal and/or social causes. Examples include GoFundMe, Causes, Crowdrise, DonorsChoose, FundRazr, and more. Generally, existing fundraising platforms enable an individual or a group to create a campaign, solicit donors through a variety of other platforms such as, for example, social media platforms like Facebook, Instagram, and Twitter, and receive the donations through the giving platform. The fundraising platforms are relatively one dimensional in that they are not directly linked to action on the part of the fundraiser or beneficiary or, if they are linked to action, they fail to provide any kind of accountability mechanism that ensures completion of the action prior to a release of the pledged funds. As a result, existing technological platforms for fundraising fail to connect fundraising efforts with any kind of accountable fundraiser action in a manner that both increases fundraising ability, monetizes the platform, and encourages positive action on the part of the fundraiser and/or the beneficiary.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a system for fundraising based on a development of relational fitness skills. The system may include a collaboration, reporting, and payment application accessible to a user athlete terminal and a supporter terminal. The collaboration, reporting, and payment application includes a graphical user interface configured to interact with at least one user athlete and at least one user supporter and to access a collaboration, reporting, and payment server via a communication channel, where the collaboration, reporting, and payment server has a non-transitory computer readable medium storing instructions for execution by a processor that accesses a storage system storing a challenge database, a user athlete database, a user supporter database, and a transaction database. The processor executes the instructions for: (1) providing, via the graphical user interface at the supporter terminal, an invitation to the user supporter to support a fundraising event comprising a plurality of challenge activities for completion by the user athlete over a fundraising event time period; (2) receiving, via the graphical user interface at the supporter terminal, a support pledge from the user supporter; (3) providing, via the graphical user interface at the user athlete terminal, the plurality of the challenge activities for completion by the user athlete; (4) receiving from the user athlete, via the graphical user interface at the user athlete terminal, a proof of completion for each of the plurality of the challenge activities completed by the user athlete; and (5) transferring, based on the proof of completion for each of the plurality of the challenge activities completed by the user athlete, the support pledge to a beneficiary of the fundraising event.

A method of practicing relational fitness abilities using a relational fitness development and fundraising tool comprising a server having a processor and a non-transitory memory, a storage system in communication with the processor and storing user athlete information, supporter information, and challenge activity information, and a collaboration, reporting, and payment application stored in the non-transitory memory for execution by the processor, the collaboration, reporting, and payment application comprising a rule module and a graphical user interface (GUI) module. The method comprises the following steps: (1) implementing a plurality of preconfigured and interactive GUI screens at a user athlete terminal and at a supporter terminal, the user athlete terminal and the supporter terminal in communication with the server via a network; and (2) selectively operating, via the plurality of the preconfigured and interactive GUI screens at the user athlete terminal and the supporter terminal, the collaboration, reporting, and payment application in one of a daily challenge mode involving a user athlete completing a daily challenge activity each day, a training mode involving the user athlete completing a plurality of training challenge activities that each relate to one of a plurality of relational fitness training content modules, a tournament mode involving the user athlete completing a plurality of tournament challenge activities in competition with other user athletes, and a fundraising mode involving the user athlete completing a plurality of fundraising challenge activities in exchange for a support pledge from a supporter at the supporter terminal.

Yet another embodiment provides a computer-controlled system for raising funds for a beneficiary based upon a user athlete's completion of one or more challenge activities that promote relational fitness, comprising: (1) a server having a processor and a non-transitory memory; (2) a storage system in communication with the processor; (3) a collaboration, reporting, and payment application stored on the non-transitory memory, the collaboration, reporting, and payment application comprising a rule module and a graphical user interface (GUI) module, the processor accessing the storage system and executing the rule module and the GUI module for: (a) implementing a plurality of preconfigured and interactive GUI screens at a user athlete terminal and at a supporter terminal; (b) receiving, from a supporter via a first set of the preconfigured and interactive GUI screens at the supporter terminal, a pledge to pay one or more support dollars in exchange for a completion of one or more challenge activities by the user athlete during a fundraising event; (c) providing, to the user athlete via a second set of the preconfigured and interactive GUI screens at the user athlete terminal, the one or more of the challenge activities for completion by the user athlete; (d) receiving, from the user athlete via a third set of the preconfigured and interactive GUI screens at the user athlete terminal, a proof of completion for each of the one or more of the challenge activities completed by the user athlete; and (e) transferring, from the supporter via a fourth set of the preconfigured and interactive GUI screens at the supporter terminal and based on the proof of completion for each of the one or more of the challenge activities completed, the one or more of the support dollars to the beneficiary.

Other embodiments are provided.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 provides a graphic depicting a conceptual framework grounding the model of Relational Fitness;

FIG. 2 provides one embodiment of a grid summarizing the twelve relational skills of Relational Fitness;

FIG. 3 provides one embodiment of a relational style grid according to the Relational Fitness model of FIG. 1;

FIG. 4 provides a block diagram depicting illustrative environments where various techniques described herein may be implemented according to some embodiments of a Relational Fitness development and fundraising system;

FIG. 5 provides a block diagram depicting illustrative Relational Fitness collaboration, reporting, and payment software according to some embodiments;

FIG. 6 illustrates one embodiment of a signup/login screen presented via a user terminal by a graphical user interface (GUI) module of the collaboration, reporting, and payment software of FIG. 5;

FIGS. 7-8 illustrate respective exemplary user athlete login and signup screens presented via the user terminal of FIG. 6;

FIG. 9 illustrates an exemplary fundraising supporter signup screen presented via the user terminal of FIG. 6;

FIGS. 10A-10C illustrate an exemplary scrollable home screen presented via the user terminal of FIG. 6;

FIGS. 11A-11B illustrate an exemplary scrollable daily SPARC³ challenge activity screen presented via the user terminal of FIG. 6;

FIG. 11C illustrates an exemplary proof of completion screen presented via the user terminal of FIG. 6, from which a user athlete may upload proof of completion of the challenge activity shown in FIGS. 11A-11B;

FIG. 12A illustrates an exemplary menu of options presented via the user device of FIG. 6;

FIG. 12B provides an exemplary invite friends screen presented via the user terminal of FIG. 6 and accessible from the menu of FIG. 12A;

FIG. 12C provides an exemplary my tribe screen listing the members of a user athlete's personal network or tribe, presented via the user terminal of FIG. 6 and accessible from the menu of FIG. 12A;

FIG. 12D provides an exemplary my profile screen that enables a user athlete to update their user information, presented via the user terminal of FIG. 6 and accessible from the menu of FIG. 12A;

FIG. 12E provides an exemplary create a group screen, presented via the user terminal of FIG. 6 and accessible from the menu of FIG. 12A, through which a user athlete may select members from their tribe to form a group;

FIG. 12F provides an exemplary invite supporters screen presented via the user terminal of FIG. 6 and through which a user athlete may invite one or more supporters to pledge their monetary support for the athlete in completing SPARC³ challenge activities;

FIG. 13 provides an exemplary modes of use screen presented via the user terminal of FIG. 6 and through which a user athlete may access various modes of use of the software application of FIG. 5;

FIG. 14A provides an exemplary training mode screen presented via the user terminal of FIG. 6 and through which a user athlete may operate the software of FIG. 5 in a training mode;

FIGS. 14B-14D provide three exemplary SPARC³ challenge screens, presented via the user terminal of FIG. 6 and accessible from the training mode screen of FIG. 14A, for a user athlete to complete when operating the software of FIG. 5 in the training mode;

FIG. 14E provides an exemplary inspirational library screen presented via the user terminal of FIG. 6 and accessible from the training mode screen of FIG. 14A;

FIG. 14F provides an exemplary set of inspirational quotes presented via the user terminal of FIG. 6 and accessible from the inspirational library screen of FIG. 14E;

FIG. 15A provides an exemplary tournament mode screen presented via the user terminal of FIG. 6 and through which a user athlete may operate the software of FIG. 5 in a tournament mode to create, join, and/or review a competitive tournament;

FIG. 15B provides an exemplary tournament invitation screen presented via the user terminal of FIG. 6 and through which a user athlete may invite other user athletes to join a competitive tournament when operating the software of FIG. 5 in the tournament mode;

FIG. 15C provides an exemplary tournament player screen presented via the user terminal of FIG. 6 and showing a status of a plurality of tournament invites sent via the tournament invitation screen of FIG. 15B;

FIG. 16 provides an exemplary fundraising mode screen presented via the user terminal of FIG. 6 and through which a user athlete may operate the software of FIG. 5 in a fundraising mode to create, join, and/or review a fundraising event; and

FIG. 17 provides a flowchart depicting and exemplary method of fundraising using the integrated Relational Fitness development and fundraising tool and collaboration, reporting, and payment software of FIGS. 4 and 5.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

### Conceptual Framework

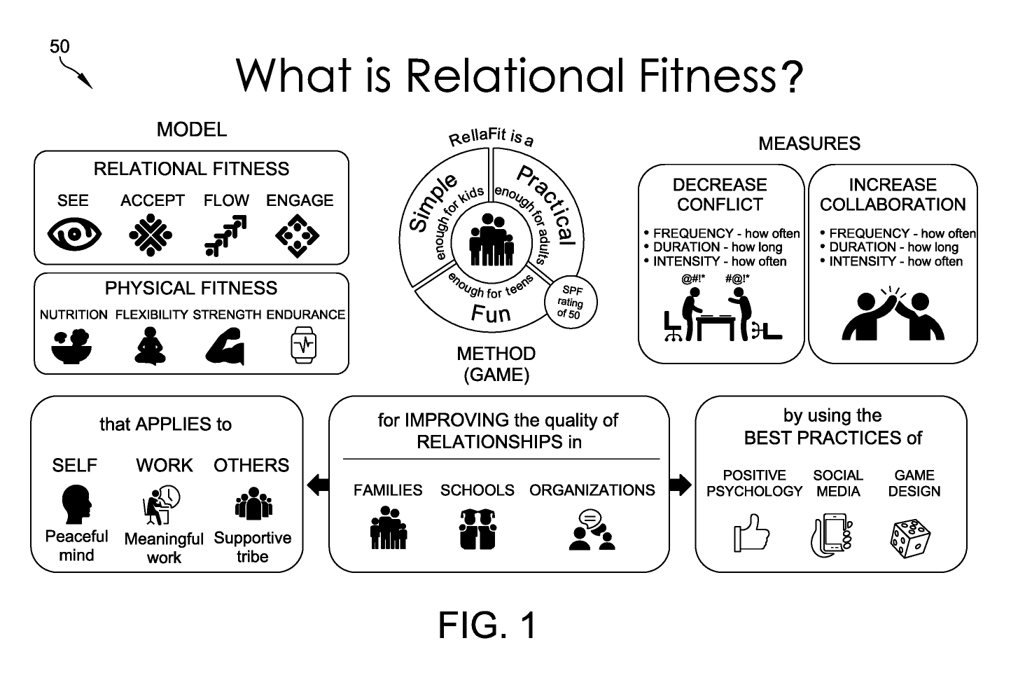

The technology discussed herein is based upon a conceptual framework and a method known as Relational Fitness, or RellaFit™, which is based on research from the field of Positive Psychology, the principles of the Strengths Model, insights from Personality Psychology, and the practices found in Social/Emotional Learning. The Relational Fitness model is a collection of innovative tools and methods that provide an improved way to incentivize kids, teens, and adults to perform the daily practices that foster wellness and involves a model, method, and measures that are summarized in the pictogram 50 provided in FIG. 1 and explained below. The Relational Fitness model can be broken down into two separate concepts: “relational” and “fitness.”

The “relational” component of Relational Fitness is defined as the interaction of ideas and experiences that occur within ourselves (our minds), between ourselves and others (our friends, family, and co-workers), and between us and the world or life (our work, hobbies, and activities). With respect to the self, our relationship with ourselves occurs at the intrapersonal level. It includes activities such as thinking (quality and quantity), feeling (fear, loneliness, peace, fulfillment, happiness, etc.), and actions (choices, behavior, habits). To enhance our relationship with self, Relational Fitness integrates practices such as mindfulness, meditation, study, affirmations, and emotional self-regulation, among others.

With respect to others, our relationship with others occurs at the interpersonal level. It includes activities such as communication (quality and quantity), conflict (disagreements, arguments, fights, etc.), and collaboration (friendship, teamwork, and co-creation). To enhance our relationship with others, Relational Fitness integrates practices such as active listening, leadership, followership, and service learning, among others.

With respect to the world or life, our relationship with the world occurs at the integral level. It includes activities such as career (vocation, job, education), tasks of daily living (money, cooking, cleaning), choices (cost/benefit, problem solving, etc.), and habits (patterns of behavior). To enhance our relationship with the world, relational fitness integrates practices such as collaborative brainstorming, dynamic planning, fit finding, and flow, among others.

The “fitness” component Relational Fitness speaks to the active nature of the method. Just as physical fitness does not improve by talking or thinking about the body, Relational Fitness does not improve without consistent practice, or, in other words, training. Currently, most of what is considered self-improvement training occurs through words—talking (counseling), reading (self-help books), listening (seminars, TedTalks, etc.), or test taking (personality profiling tests, aptitude tests). This type of passive absorption of information is insufficient to create the mental, emotional, and behavioral changes that most people desire. As Bruce Lee noted, “Under duress, we do not rise to our expectations, we fall to the level of our training.” Healthy mental, emotional, and relational practices only become active in the “day to day” of our lives if we have a way to train our minds to act and react as we would prefer.

Just as physical fitness consists of four elements (nutrition, flexibility, strength, and endurance), Relational Fitness consists of four elements or abilities—see more clearly, accept more easily, flow more naturally, and engage more deeply (see, accept, flow, and engage) with the self, others, and the world/life for improving the quality of relationships in families, schools, and organizations—and provides a broad menu of healthy mental, emotional, and relational practices that are influenced by positive psychology, social media, and game design and that can be used to strengthen the four Relational Fitness abilities and achieve six key performance indicators—a decrease in the frequency, intensity, and duration of conflict and an increase in the frequency, intensity, and duration of collaboration.

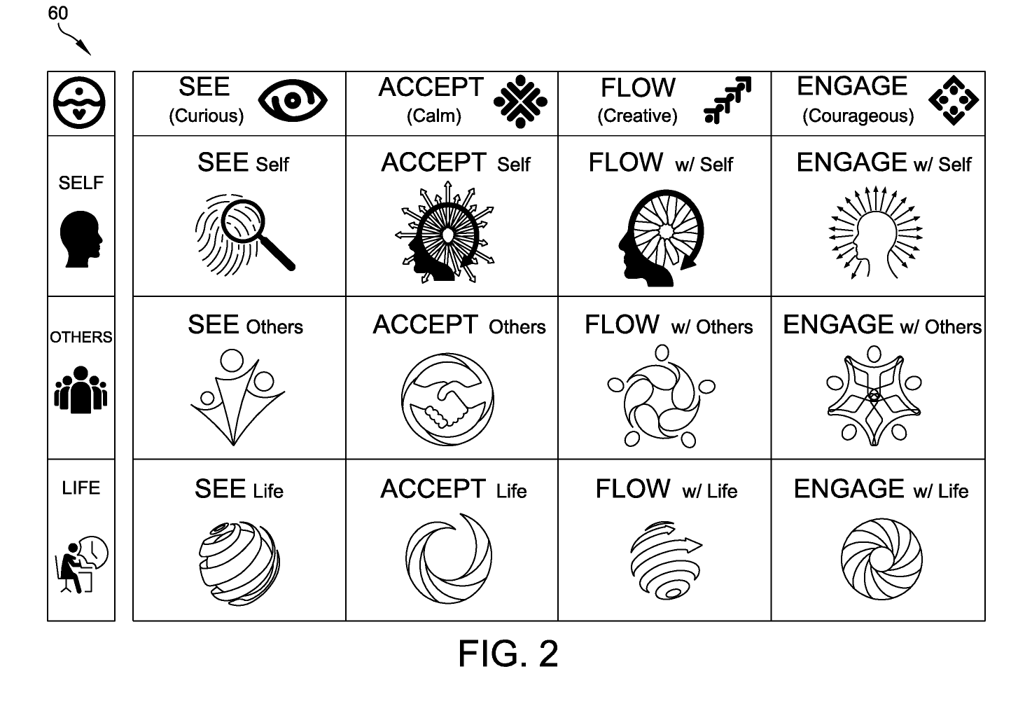

The four abilities of Relational Fitness—see, accept, flow, and engage—represent the acronym S.A.F.E. Unless a person feels some level of emotional safety, he or she is unlikely to try out new behaviors, share vulnerable feelings, or take the risks necessary to learn, grow, and change. The Relational Fitness model, as embodied in the technological tools discussed below, specifically creates a safe environment to test out new practices by (1) involving trusted friends, family, or and/or co-workers in the experience; (2) working collaboratively as part of a team; (3) using a good amount of humor, storytelling, and entertainment vs. “psychobabble;” (4) making the content relevant by linking to modern entertainment (music, movies, TV shows); and (5) folding the experience into a competitive activity rather than a traditional, passive self-help experience (e.g., testing, reading, counseling, seminar, etc.). Combining the four abilities of Relational Fitness (see, accept, flow, and engage) with the three relationships (self, others, world) creates a grid 60 of twelve Relational Fitness skills, shown in FIG. 2.

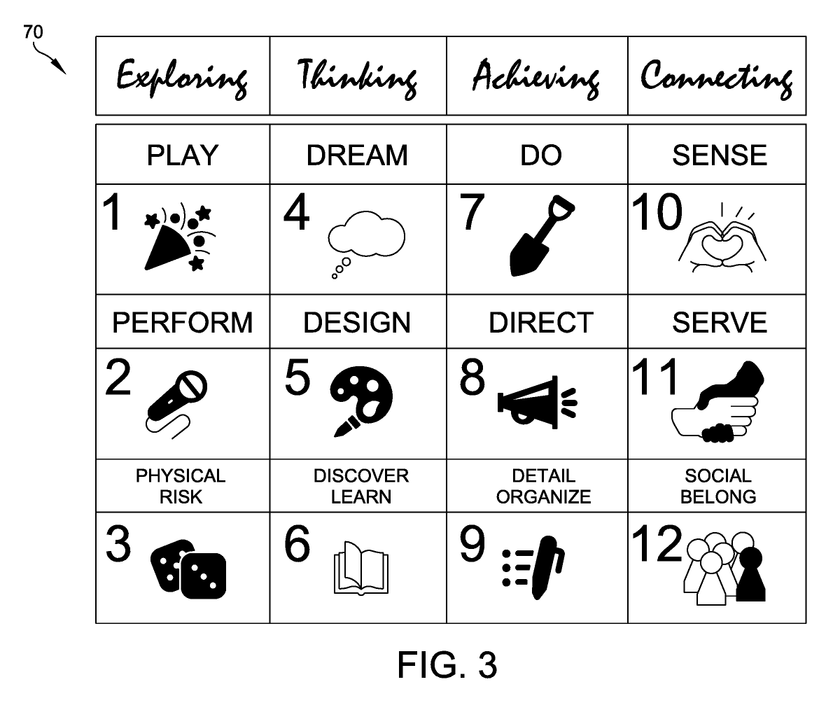

FIG. 3 provides a relational style grid 70 that serves as a basis for the system and methods discussed herein, as it represents a person's way of thinking speaking, and acting in the world that creates a sense of fulfillment and energy. The relational style grid 70 provides a matrix of relational styles broken down into four primary style categories: exploring, thinking, achieving, and connecting. Each of the primary styles includes three associated subcategories or relational styles: play, perform, and physical/risk for the exploring style; dream, design, and discover/learn for the thinking style; do, direct, and detail/organize for the achieving style; and sense, serve, and social/belong for the connecting style. Thus, in this embodiment, there are twelve total relational styles represented on the grid 70. Understanding a style profile for oneself and others in terms of the style grid 70 allows a person to increase a user's awareness self, others, and the world, and is detailed further in the tools disclosed in Provisional Patent Application Nos. 62/573,599, filed Oct. 17, 2017 for “SYSTEMS AND METHODS FOR FACILITATING PERSONAL CONNECTIONS,” and 62/575,826, filed Oct. 23, 2017 for “MOBILE CONNECTION-FACILITATION SYSTEM AND METHODS,” both of which patent applications are hereby incorporated herein by reference.

Just as there are thousands of methods to increase physical fitness (running, swimming, diet, sports, etc.) there are thousands of methods to strengthen Relational Fitness skills. Finding the one that fits each unique individual is the key. The tools and associated methods described herein tailor the improvement of Relational Fitness for each unique individual, rather than assuming that one size will fit all.

While practicing the Relational Fitness abilities is certainly key to strengthening relationships with one's self, others, and the world, motivating such practice can be challenging in today's hectic, device-driven society where personal interaction oftentimes takes a back seat to other online and/or virtual activities that generally do not lead to wellness. The system and methods disclosed herein provide improved technological platforms that motivate users in a variety of ways. Use is simple, practical, and fun and involves competition, popular culture, and the electronic devices (e.g., smartphones, tablet computers, laptops, etc.) that people have grown so used to and dependent upon. In this regard, users practice the Relational Fitness abilities because they are interested and engaged. Moreover, the disclosed system and methods employ an integrated fundraising tool that provides further motivation for users, a unique monetization mechanism for the system and its operator, and an accountability feedback loop for monetary supporters that ensures sponsored activities are completed prior to a payment of sponsorship dollars. This innovative combination improves upon existing online and/or computerized technologies that promote and improve wellness and/or facilitate fundraising on behalf of individuals and/or groups, and leads to a more widespread practice of Relational Fitness abilities and satisfied, enriched supporters/sponsors, which in turn, enables users and supporters to work together to improve the state of wellness in the U.S. and the world.

### Exemplary Systems and Methods

### Integrated Relational Fitness Development and Fundraising Tool

The technology discussed herein relates to systems and methods for facilitating innovative and unique ways for individuals, families, groups, organizations, and companies to improve the quality of their relationships, with themselves, others, and the world, by applying technological solutions incorporating positive psychology, perennial philosophy, wisdom traditions, and fundraising techniques. Users may derive the interpersonal benefits of the tools described herein while feeling as though they are engaged in play, or a game, that leverages social media and popular culture as experienced through movies, TV shows, music, and more.

Generally, when elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software or in a combination thereof (including firmware, resident software, micro-code, state machines, gate arrays, etc.). As used herein, a software component may include any type of computer instruction or computer executable code located within or on a non-transitory computer-readable storage medium/memory. A software component may, for instance, comprise one or more physical or logical blocks of computer instructions, which may be organized as a routine, program, object, component, module, data structure, etc., that when executed performs one or more tasks or implements particular data types.

Furthermore, the subject matter may take the form of a computer program product on a computer-usable or computer-readable storage medium/memory having computer-usable or computer-readable program code embodied in the medium for use by or in connection with an instruction execution system. In the context of this document, a computer-usable or computer-readable storage medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, computer readable media may comprise computer storage media and communication media.

Computer storage media/memory includes volatile and nonvolatile, removable and non-removable, non-transitory media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by an instruction execution system.

Communication media typically embodies computer readable instructions, data structures, program modules or other data in a modulated data signal such as a carrier wave or other transport mechanism and includes any information delivery media/channel. The term “modulated data signal” means a signal that has one or more of its characteristics set or changed in such a manner as to encode information in the signal. By way of example, and not limitation, the term communication media or channel includes wired media such as a wired network or direct-wired connection, and wireless media such as satellite, wireless networking technologies (e.g., Wi-Fi, WLAN, WiMAX), acoustic, RF, infrared, Bluetooth, and other wireless media. Combinations of the any of the above should also be included within the scope of communication media and/or channels.

When the subject matter is embodied in the general context of computer-executable instructions, the embodiment may comprise program modules or tools, executed by one or more systems, computers, processors, or other devices. Generally, program modules include routines, programs, objects, components, data structures, etc. that perform particular tasks/functions or implement particular abstract data types. Typically, the functionality of the program modules may be combined or distributed as desired in various embodiments. Software implementations may include one or more computer programs comprising executable code/instructions that, when executed by a processor, may cause the processor to perform a method defined at least in part by the executable instructions. The computer program can be written in any form of programming language, including complied or interpreted languages, and can be deployed in any form, including as a standalone program or as a module, component, subroutine, or other unit suitable for use in a computing environment.

In general, system users earn points, or in some embodiments, fundraising dollars, by completing short challenge activities, or “Small Positive Acts that Renew your Connection to yourself, others, and life” (SPARC³s), that provide opportunities to practice (not merely talk about) relational skills/abilities in real life. Some challenges require creating art, some involve asking a question of a friend (or a stranger), and others challenge users to perform acts of random kindness or even silliness. For description purposes, system users may be referred to as players or “athletes” because Relational Fitness is based on the principles of physical fitness. Learning happens by doing.

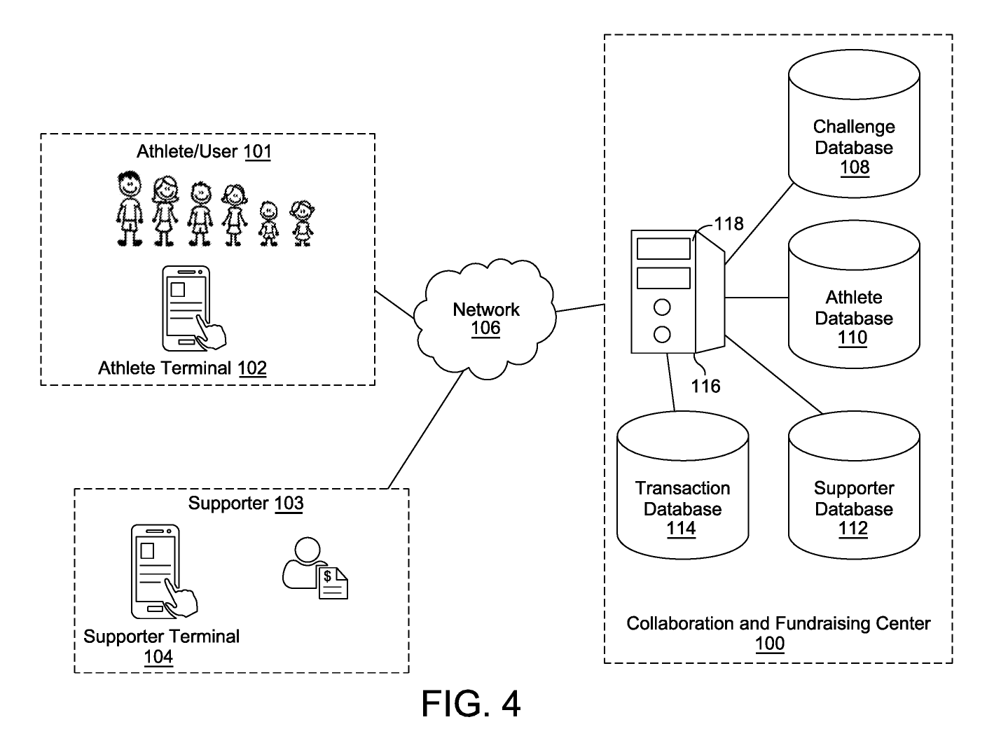

Turning to specific embodiments, FIG. 4 provides a block diagram depicting illustrative environments where various techniques described herein may be implemented according to some embodiments of a Relational Fitness development and fundraising system. As shown, a collaboration and fundraising center 100 may be communicatively coupled with a user athlete 101 at a user terminal, or an “athlete” terminal 102, and a supporter 103 at a supporter terminal 104 via a network 106 of communication channels which may include, for example, the Internet. Additionally or alternatively, the network 106 may include wireless cellular networks or the like.

In some embodiments, the collaboration and fundraising center 100 may include a challenge database 108 storing information relating to a bank of challenge activities, or SPARC³s, for completion by user athletes 101, each within a defined completion time period. The collaboration and fundraising center 100 may also include a user-athlete database 110 storing contact and other demographic information for each user athlete 101, a supporter database 112 storing contact and other demographic information for each fundraising supporter 103 who pledges to donate money to user athletes 101 based upon a number of challenge activities, or SPARC³s, completed by the user athletes 101, and a transaction database 114 storing data reflecting each challenge completed, point tallies for each user athlete and/or team of user athletes, dollar amounts pledged by supporters, dollar amounts paid by supporters, and other information reflecting system transactions made by its users.

Each of the challenge database 108, the athlete database 110, the supporter database 112, and the transaction database 114 may be communicatively coupled with a collaboration, reporting, and payment server 116 running one or more collaboration, reporting, and payment processors 118, as shown in the schematic of FIG. 4.

Generally speaking, the databases 108, 110, 112, 114 may include any suitable type of application or data structure that may be configured as a data repository. For example, the databases may be configured as relational databases that include one or more tables of columns and rows that may be searched or queried according to a query language, such as a version of Structured Query Language (SQL). Alternatively, the databases may be configured as structured data stores that include data records formatted according to a markup language, such as a version of eXtensible Markup Language (XML). In other embodiments, the databases may be implemented using arbitrarily or minimally structured data files managed and accessible through any suitable type of application.

As shown in FIG. 4, the user athlete 101 and the supporter 103 may access the system using the respective athlete and supporter terminals 102, 104 that are configured to communicate with the collaboration, reporting, and payment server 116 for the purposes of challenge selection, challenge completion, proof of challenge progress and completion, and otherwise communicating with the server 116. The athlete terminal 102 and the supporter terminal 104 may each be any appropriate, network-enabled user computing device such as, for example, a desktop computer, a laptop computer, a tablet computer, a smartphone, and so on.

As illustrated in FIG. 4, the challenge database 108, the athlete database 110, the support database 112, and the transaction database 114, as well as the collaboration, reporting, and payment server 116 and processors 118 may be co-located at the collaboration and fundraising center 100. In some embodiments, these components, or sub-components thereof, may be combined or distributed in any appropriate manner across multiple locations and/or distributed computing platforms.

During operation of some embodiments, the collaboration, reporting, and payment server 116 may access one or more challenge activities, or SPARC³s stored in the challenge database 108 and provide those challenge activities to the user athlete 101 at the athlete terminal 102. As challenges are completed, proof of progress and/or completion may be provided via the athlete terminal 102 and stored in the transaction database 114. Upon completion, points may be awarded to the user athlete 101 or his or her team. In parallel, sponsorship pledges may be solicited from the supporter 103 via the supporter terminal 104 and sponsorship payment may be transferred after proof of challenge completion is provided, as detailed further below.

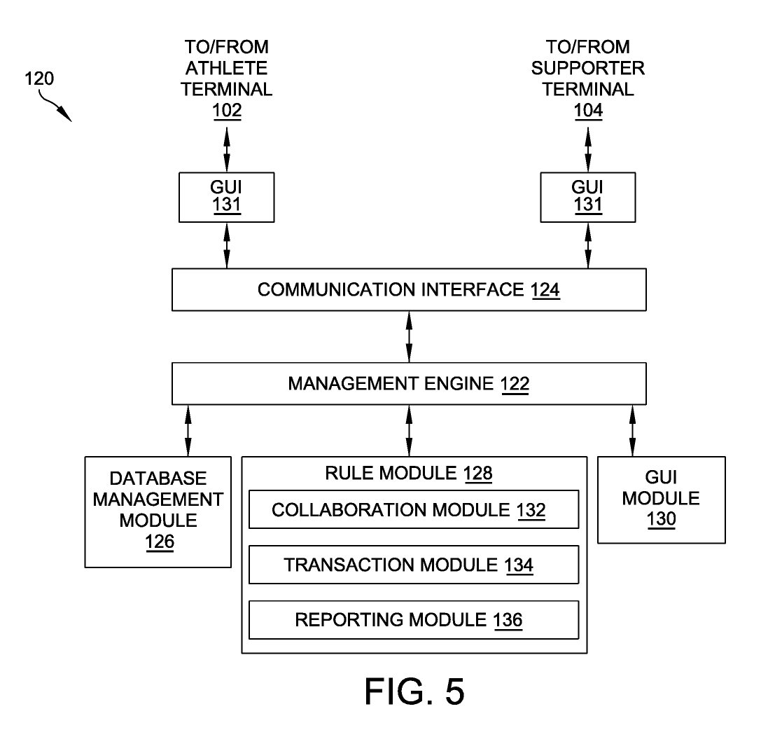

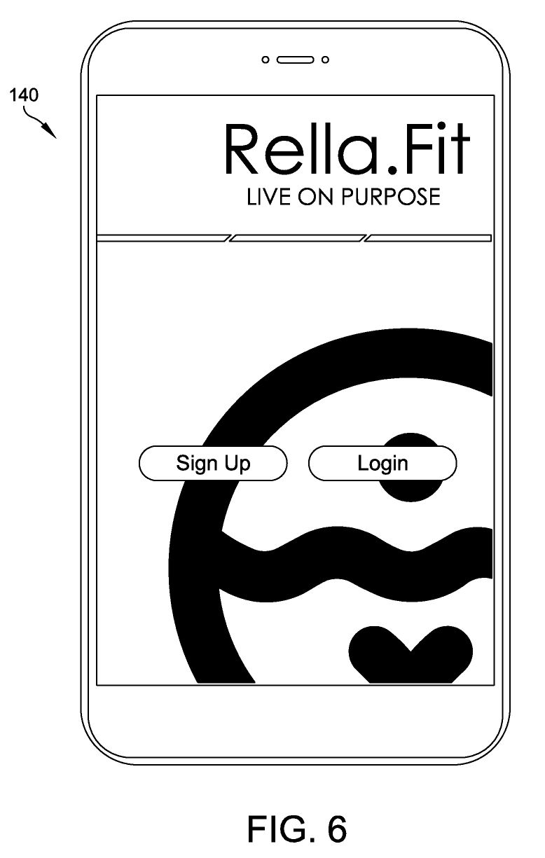

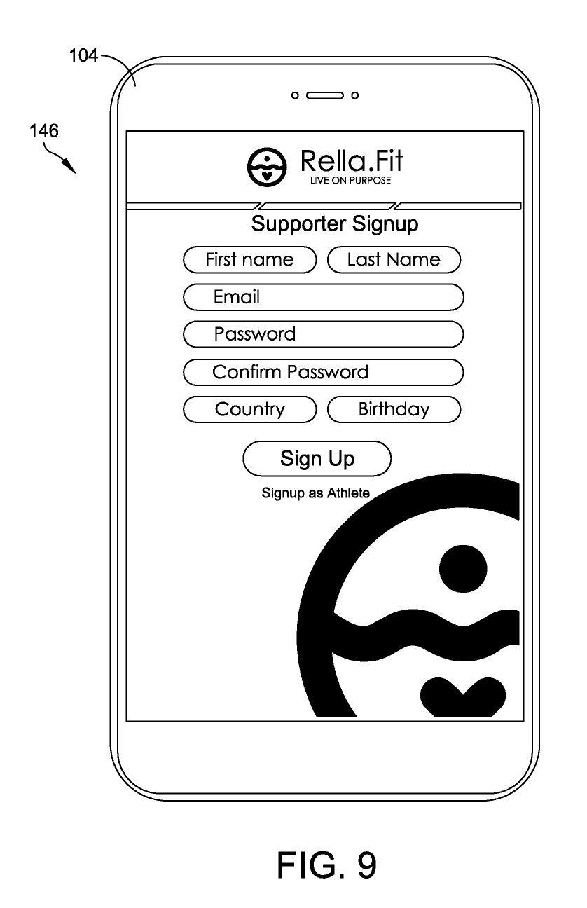

FIG. 5 provides a block diagram depicting illustrative Relational Fitness collaboration, reporting, and payment software 120 according to some embodiments. In various implementations, such software may be executed by the processors 118 of the collaboration, reporting, and payment server 116. As shown, a management engine 122 may be coupled to a communication interface 124, a database management module 126, a rule module 128, and a graphical user interface (GUI) module 130 operatively coupled with the athlete terminal 102 and the supporter terminal 104 via the communication interface 124. The management engine 122 may be configured to perform a variety of operations including those described below with respect to FIGS. 6-17.

The communication interface 124 may enable the Relational Fitness collaboration, reporting, and payment software 120 to securely exchange information with other systems and/or system components, including the user athlete terminal 102 and/or the supporter terminal 104. In some embodiments, the communication interface 124 may be configured to transmit and/or receive information using secure socket layer (SSL) encryption. Additionally or alternatively, other connections may also be used, such as, for example, XML file transmission utilizing file transfer protocol (FTP), hypertext transfer protocol (HTTP) POST transactions, or other data transmission protocols. The communication interface 124 may further include any of a variety of standardized application programming interfaces (APIs) configured to allow different software programs to communicate (e.g., to request services and respond to such requests) in an autonomous, web-based, and/or platform-independent manner. For example, the user terminal 102 may choose to expose certain data (e.g., user athlete demographic information, challenge completion or proof information) via a secured web interface. The communication interface 124 may then access the exposed data and/or functions via the appropriate API(s).

The database management module 126 may include any suitable database management system (DBMS) or application configured to manage the creation, maintenance, and use of the stored data/databases of FIG. 4. The rule module 128 may include one or more sets of rules, in any suitable format, that provide a framework for the provision of challenge activities, recordation of proof of challenge completion, and completion of point and/or sponsorship transactions, as described in further detail below. For example, the rule module 126 may include a collaboration module 132 including instructions for providing challenges to the user athlete 101 at the user athlete terminal 102. The rule module 128 may also include a transaction module 134 including instructions regarding the completion of challenges and sponsorship transactions involving one or both of points or sponsorship dollars, and a reporting module 136 including instructions for reporting any appropriate information, including, for example, the challenges served, the challenges completed, individual and/or team/group point totals, and/or sponsorship dollars raised to the patient terminal, the payer terminal, and/or the provider terminal.

The GUI module 130 may be configured to provide, for example, a web-based user interface (WUI) that implements JAVA®, AJAX®, ADOBE FLEX®, MICROSOFT.NET®, or similar technologies to provide real-time user control. In other cases, the GUI module 130 may implement a command line interface, an application interface, or another suitable interface using non-web-based technologies.

In various embodiments, a GUI 131 may be displayed to system users via the GUI module 130 of FIG. 5. The GUI 131 may be operable to display information and/or receive commands from the user (e.g., from the user athlete 101 via the athlete terminal 102 and/or from the supporter 103 via the supporter terminal 104). In various implementations, the GUI 131 may be displayed, via a number of appropriate preconfigured and interactive screens, examples of which are discussed below, that are presented to the user athlete 101 at the athlete terminal 102 and to the supporter 103 at the supporter terminal 104 via the communication interface 124 and the network 106.

A browser or application window on any of the athlete and/or supporter terminals 102, 104 may be configured to display text content, image content, input features, navigable links, etc. of the preconfigured screens of the GUI 131. Each interactive and preconfigured screen may include any appropriate type of content in various combinations, and the screen(s) displayed to the users may be specific to the viewing platform. For example, the screen(s) presented at the athlete terminal 102 may differ from the screen(s) shown at the supporter terminal 104, depending on a variety of factors including, for example, the type of information to be collected or transmitted, security concerns, user permissions, and so on. The interactive and preconfigured screens of the GUI 131 may present a branded portal having any appropriate style, look, and/or feel that is tailored to the user terminals 102, 104 (e.g., tailored for a mobile computing device vs. a desktop device).

GUI screen content may be interspersed or combined in any suitable fashion according to the capabilities of the browser and language used to implement the GUI 131, and may be displayed in any suitable area of the browser or application window. In some embodiments, the window may be generated and managed by a web browser such as, for example, MICROSOFT EXPLORER®, FIREFOX®, SAFARI®, CHROME®, etc., implemented from collaboration and fundraising center 100.

In various embodiments, the modules shown in FIG. 5 may represent sets of software routines, logic functions, and/or data structures that are configured to perform specified operations. Although these modules are shown as distinct logical blocks, in other embodiments, at least some of the functionality provided by these modules may be combined into fewer blocks or parceled into additional blocks. Conversely, any given one of the modules may be implemented such that its functionality is divided among two or more logical blocks. Moreover, although shown with a particular configuration, in other embodiments these various modules may be rearranged in other suitable ways.

FIGS. 6-16, detailed below, depict a plurality of exemplary preconfigured, interactive GUI screens that may be provided as part of an exemplary framework of one embodiment of the relational fitness collaboration, reporting, and payment software 120.

### Signup/Login

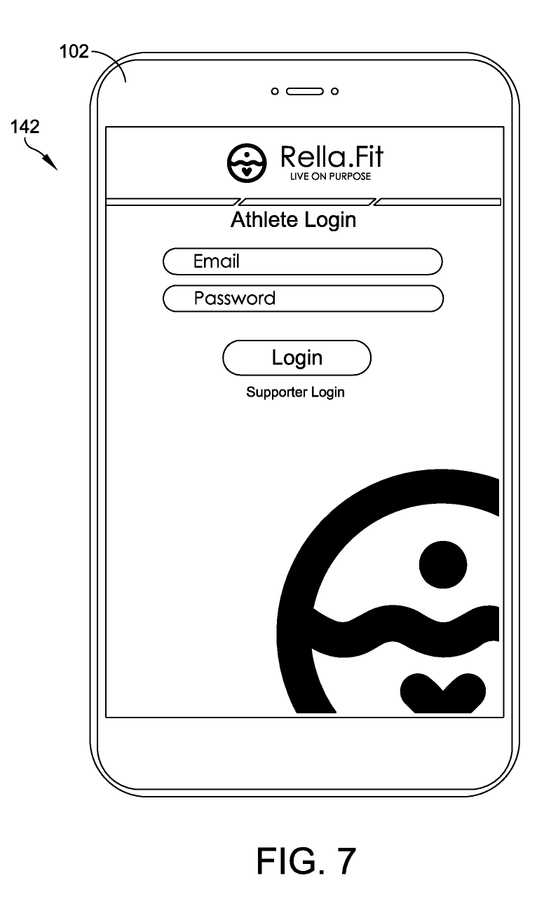

FIG. 6 illustrates one embodiment of an interactive and preconfigured home signup/login screen 140, while FIGS. 7-9 illustrate exemplary athlete login, athlete signup, and supporter signup screens 142, 144, 146, respectively. Signup for athletes 101 may require or request a user name, email, password, country, birthday, and/or a payor code that links to or verifies a payor source such as, for example, the user's paid subscription plan information or a supporter code linked to a supporter 103 who has pledged athlete sponsorship. Signup for supporters 103 may require or request a user name, email, password, country and/or birthday.

### Home

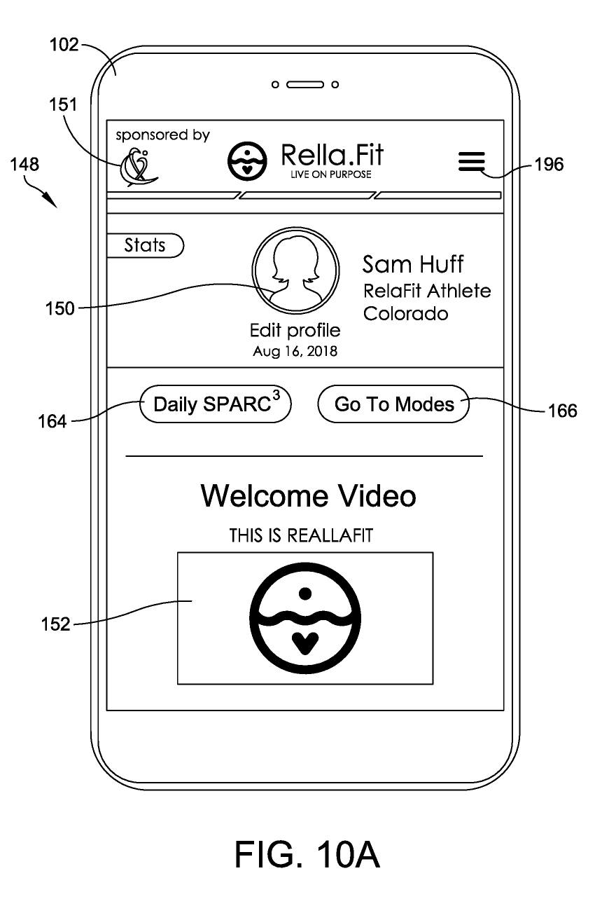

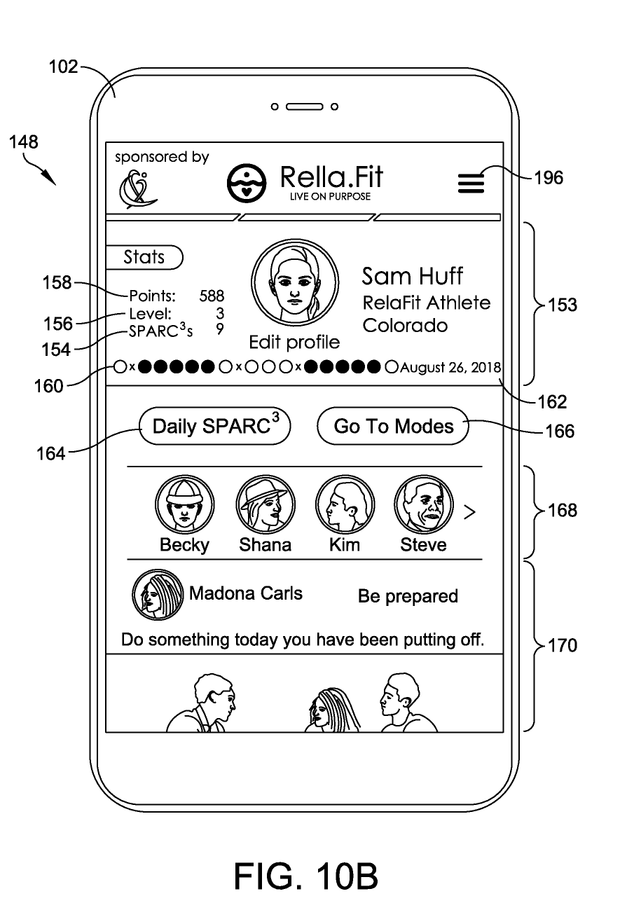

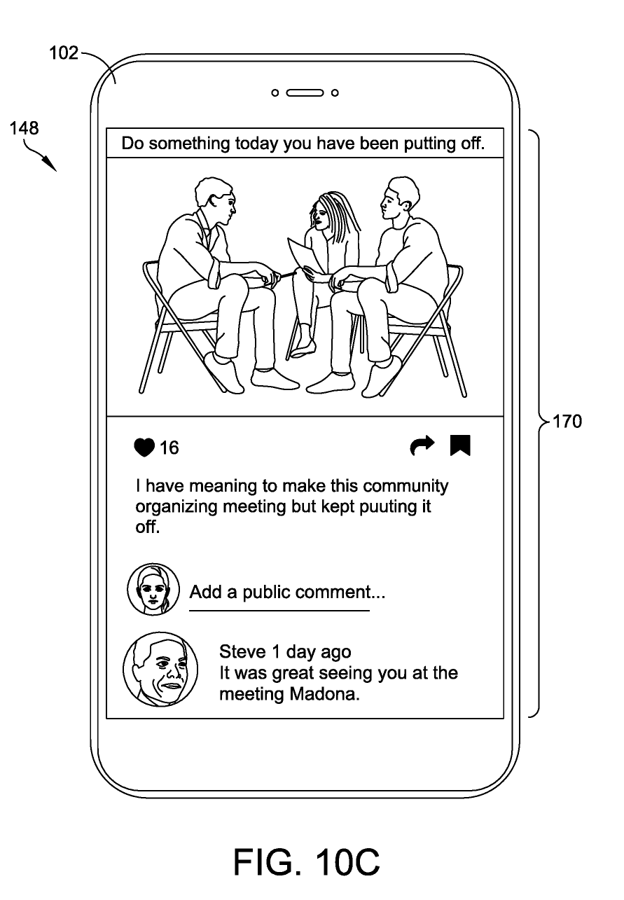

Once logged in, the user athlete 101 may be directed to a scrollable home screen 148 shown in FIGS. 10A-10C. A sponsor/supporter section 151 may appear on the home screen 148 to reflect sponsorship of the athlete or of the system, as discussed below. The sponsor may be connected to the code that verifies the payor source, which the user athlete may enter upon signup.

Upon the first login in, the user athlete 101 may edit his or her profile 150 and/or view a welcome video 152 explaining the system and application 120, as shown in FIG. 10A. The user athlete 101 may also select from a daily challenge, or a daily SPARC³, button 164 or a go to modes button 166. The daily SPARC³ 164 provides immediate access to a daily challenge activity, or a daily SPARC³, for completion on the current date, as discussed further below. The mode button 166 directs the user athlete 101 to a modes screen from which the athlete 101 may select from a variety of operational modes, as discussed further below.

Upon subsequent logins and once the user athlete 101 has established a use history, and in reference to FIGS. 10B-10C, the home screen 148 may present a current athlete info bar 153 showing his or her completed SPARC³s 154, user level 156, and accumulated points 158. For instance, the athlete info bar 153 of FIG. 10B shows that a user athlete Sam Huff has uploaded her profile picture, completed 9 challenge activities (SPARC³s), earned 588 points through the completion of challenge activities, and reached a level 3.

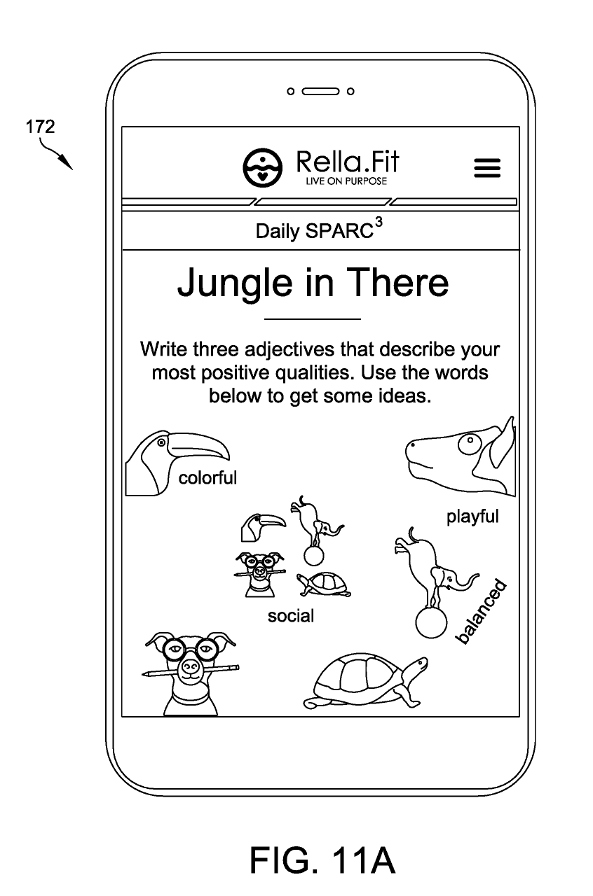

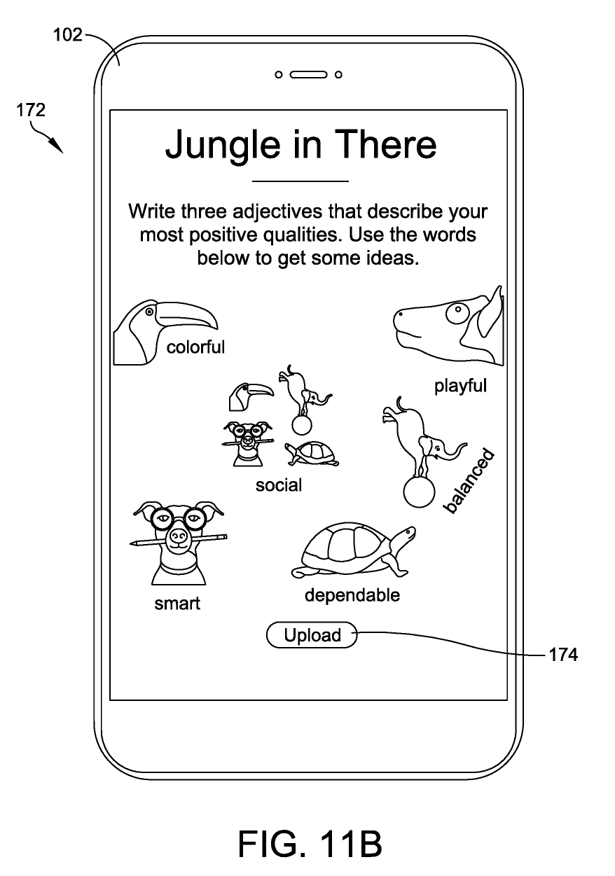

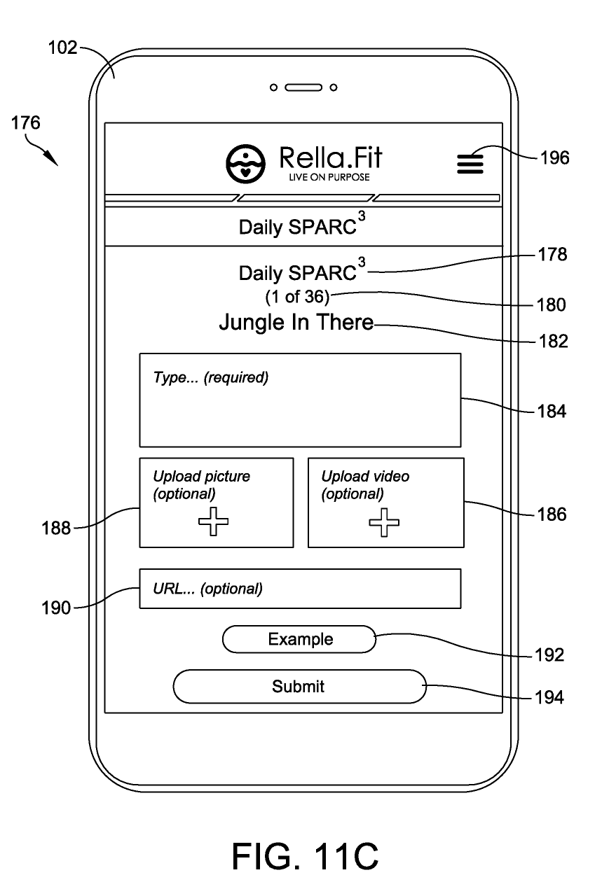

The athlete info bar 153 may also present a daily SPARC³ record 160 that keeps track of a number of daily SPARC³s, discussed further below in relation to FIGS. 11A-11C, that have been completed by the user athlete 101. In this embodiment, a filled circle indicates that a daily SPARC³ has been completed, and an empty circle indicates the daily SPARC³ for that day was not completed. Points may be awarded according to any appropriate and/or desirable point scheme. For example, once daily SPARC³s have been completed 5 days in a row, and each circle has been filled for those 5 SPARC³s, the athlete may then receive +210 bonus points for completing a challenge streak.

A current date 162 may appear in the athlete info bar 153. In one embodiment, if the daily SPARC³ is completed for a particular date, the date may disappear from the athlete info bar 153, and a filled circle may appear in place of the date indicating the SPARC³ has been completed for that day. The athlete info bar 153 may be provided on the home screen 148, as shown in FIG. 10B, and may additionally be provided on any other appropriate and/or desired screens provided to the user during operation of the software application 120.

The home screen 148 may also present a my tribe bar 168, which displays names and profile pictures of other athletes within the user athlete's network, or tribe. A mechanism enabling user athletes 101 to add tribe members in building a tribe is detailed further below.

As shown in FIGS. 10B-10C, the home screen 148 may also include a scrollable feed section 170 below the my tribe bar 168. The feed section 170 may provide an interactive feed through which the athlete 101 may engage with his or her tribe or with supporters 103. For example, the feed section 170 may include completed SPARC³ information for the other athletes 101 in the user athlete's tribe, with the most recent completion posts appearing on top and including the profile picture and name of the athlete that complete the SPARC³, as well as the time a proof of completion was uploaded, the type of challenge completed, the challenge name, and a short description of the challenge for the completed SPARC³. The feed 170 includes features that allow the athlete 101 to engage with the tribe member through comments and encouragements, allow the athlete 101 to forward the particular challenge to others (via text, email, or through the application), and/or to save the challenge for later reference.

### Daily SPARC³ Challenges

As discussed above, the athlete 101 may select the daily SPARC³ button 164 from the home screen 148 to access a daily SPARC³ display screen 172, as shown in FIGS. 11A-11B. In one embodiment, there may be 36 daily SPARC³s, one for each of 36 Relational Fitness practices (e.g., know yourself, look inward, hear feedback, etc.). In other embodiments, the application 120 may include any appropriate number and/or variety of daily SPARC³s.

Within the daily SPARC³ display screen 172, one SPARC³ may appear each day (e.g., 1 second after midnight based on the time settings on the phone) and disappear at midnight. For example, and as shown in FIGS. 11A-11B, a daily SPARC³ may require the athlete 101 to “Write three adjectives that describe your most positive qualities. Use the words below to get some ideas.” The athlete 101 may complete the SPARC³ within the 24 hour daily challenge period to receive credit/points.

Once a SPARC³ is completed, the athlete may select an upload button 174 to enter a proof of completion screen 176, shown in FIG. 11C. In some embodiments, the proof screen 176 may define a type 178 of SPARC³ completed (e.g., daily SPARC3 or a challenge completed in another operational mode), an identifying code 180 for the SPARC³ (e.g., 1-36), and a name 182 of the SPARC³. The proof screen 176 may also include a type field 184, a video upload field 186, a picture upload field 188, and a URL field 190. The type filed 184 allows the athlete 101 to enter a description of how the athlete 101 completed the SPARC³, while the video and picture upload fields 186, 188 allow the athlete to upload one or more pictures or videos of the completed SPARC³. The URL field allows the athlete 101 to paste one or more URLs as part of their proof of completion.

In one embodiment, the proof screen 176 may also include an example button 192, which may be selected to view an example of how another athlete completed the present SPARC³. Once the athlete 101 has entered their proof of completion, they may select a submit button 194 to record and save their completed SPARC³, after which the athlete 101 is rewarded points that are reflected on the home screen 148 and/or athlete info bar 153.

### Menu

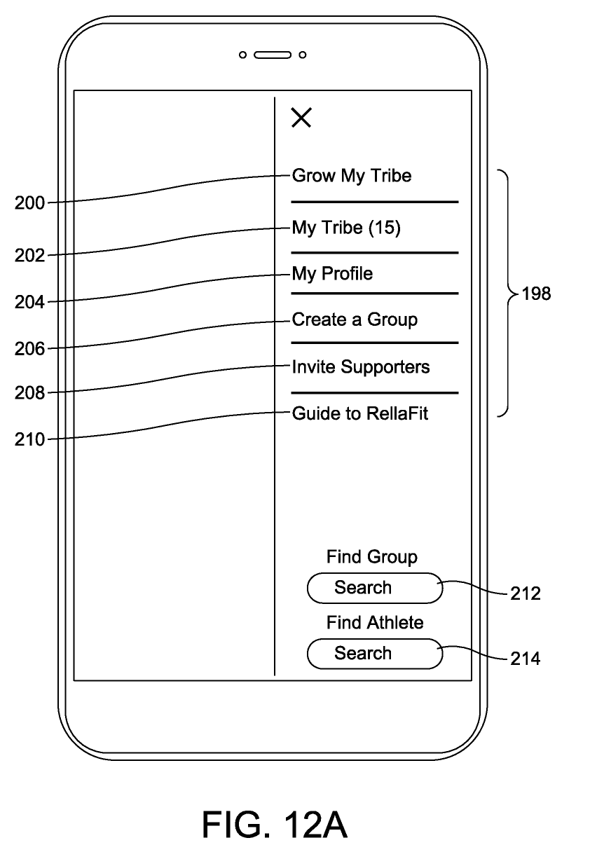

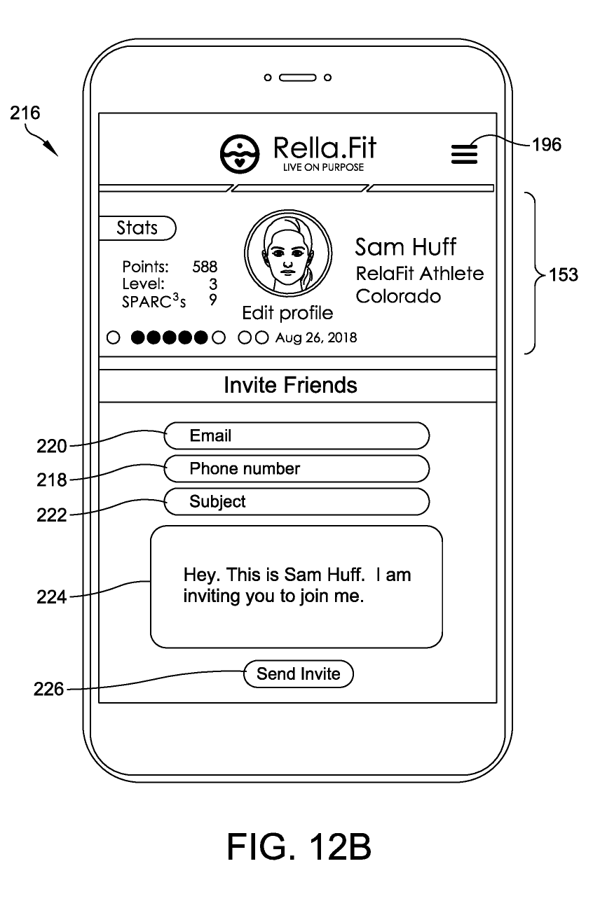

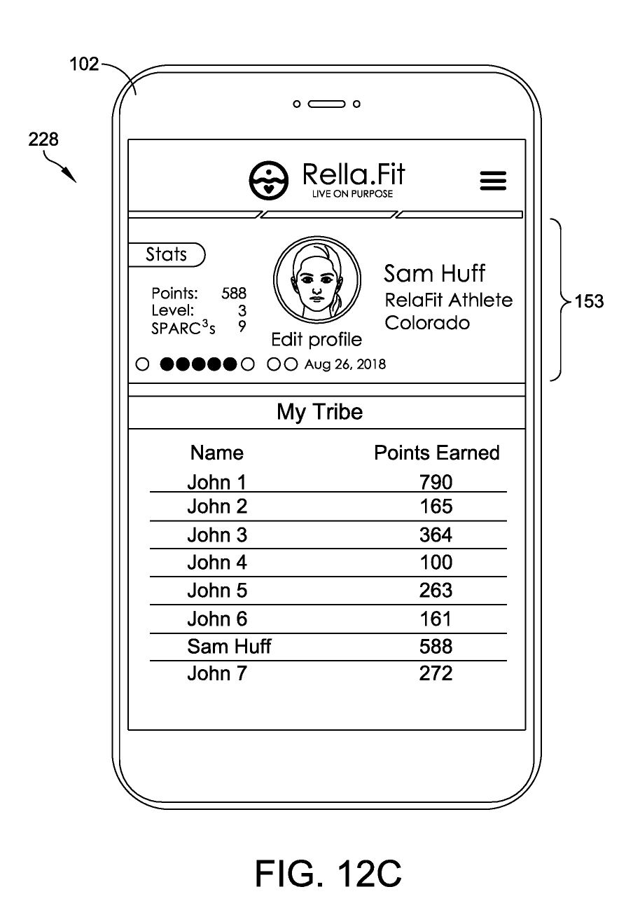

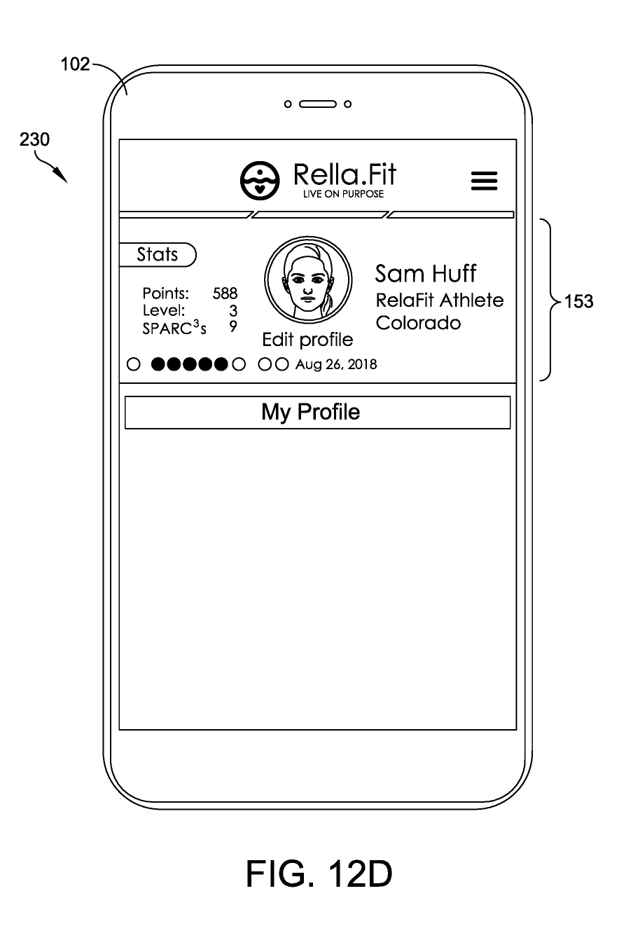

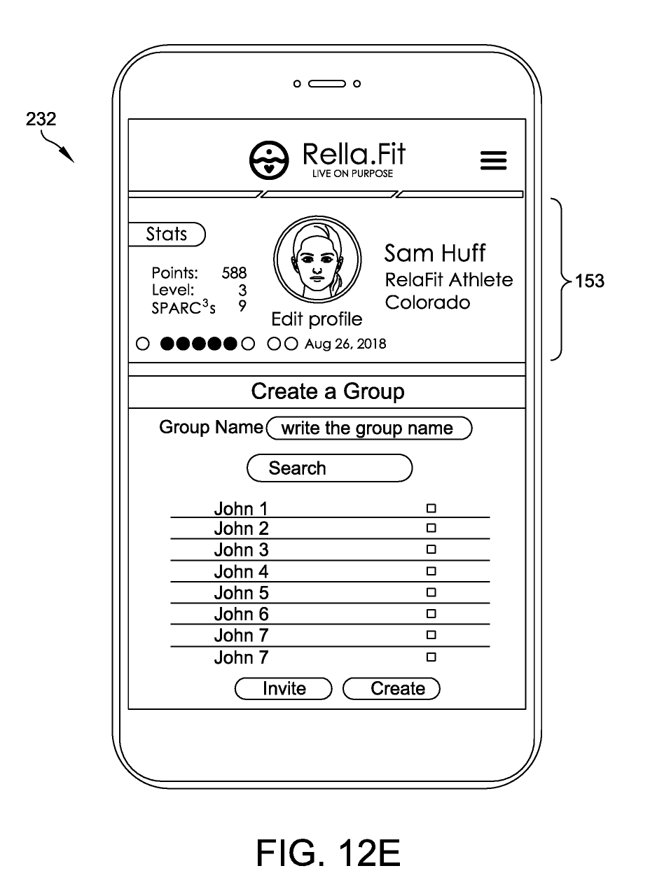

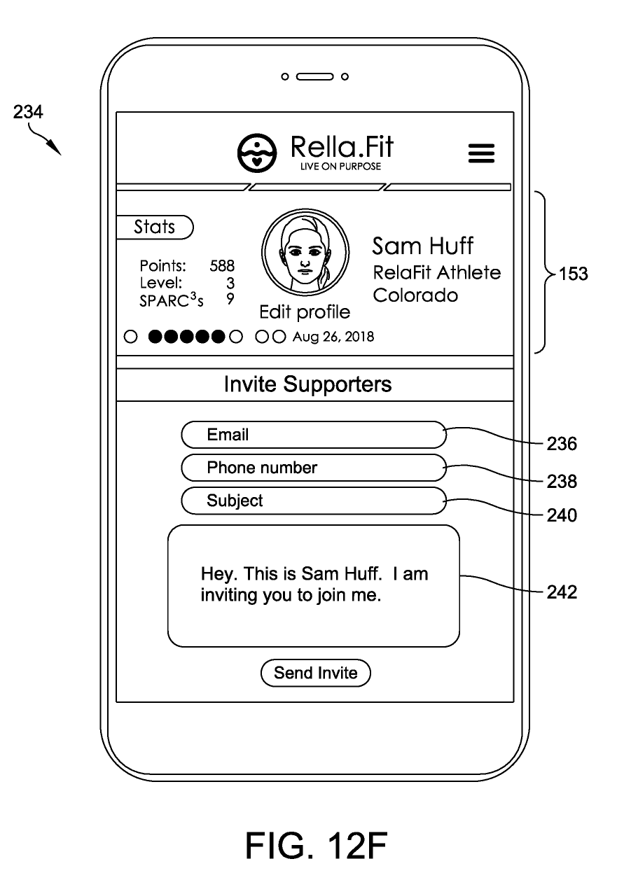

Returning to the home screen 148 of FIG. 10A, the user may select a menu button 196 to access a menu 198 of option links, shown in FIG. 12A. The menu options may include, for example, a grow my tribe link 200, a my tribe link 202, a my profile link 204, a create a group link 206, an invite supporters link 208, and a guide link 210 that links to a training library regarding system use. The menu 198 may also include group and athlete search bars 212, 214, respectively.

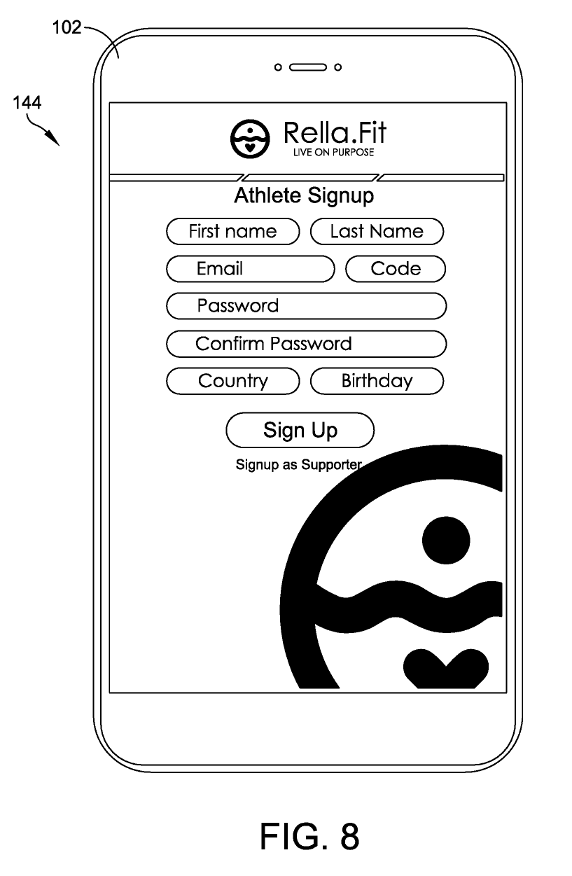

FIG. 12B provides an exemplary invite friends screen 216, which allows the user athlete 101 to invite people who are not currently enrolled in the system to sign up and to join their tribe. The invite friends screen 216 may feature phone, email, and subject fields 218, 220, 222, along with a message field 224. The athlete 101 may send a preloaded stock message or draft their own message for the recipient. Once the athlete selects a send invite button 226, the invite is sent along with a link that connects the recipient to the athlete sign up screen 144, an example of which is shown and discussed in relation to in FIG. 8.

FIG. 12C provides one embodiment of a my tribe screen 228, which may list all of the athlete members of the athlete's tribe, along with the points earned by each of the members.

FIG. 12D provides an exemplary my profile screen 230, which enables the athlete to update their user information including, for example, their name, email and phone number, password, privacy settings, history of SPARC³s completed, and any affiliations with one or more supporters.

FIG. 12E provides an exemplary create a group screen 232, through which the user athlete 101 may select members from their tribe to form a group. In one embodiment, the group may be affiliated with a sponsorship code that is linked to a particular group supporter who has pledged to pay sponsorship dollars for completion of SPARC³s by the group.

FIG. 12F provides one example of an invite supporters screen 234. Through the invite supporters screen 234, athletes 101 may contact supporters (e.g., friends, family, neighbors, etc.) to donate money for a beneficiary. The beneficiary might be a cause the athlete 101 is trying to raise money for that benefits them or their group (e.g., trip, college, etc.) or that benefits an organization (e.g., charity). In either case, the invite supporters screen 234 includes email, phone, subject, and message fields 236, 238, 240, 242 and allows the athlete 101 to send a stock or a custom message to a potential supporter 103 via email and/or phone inviting the potential supporter to pledge their support or sponsorship.

### Use Modes

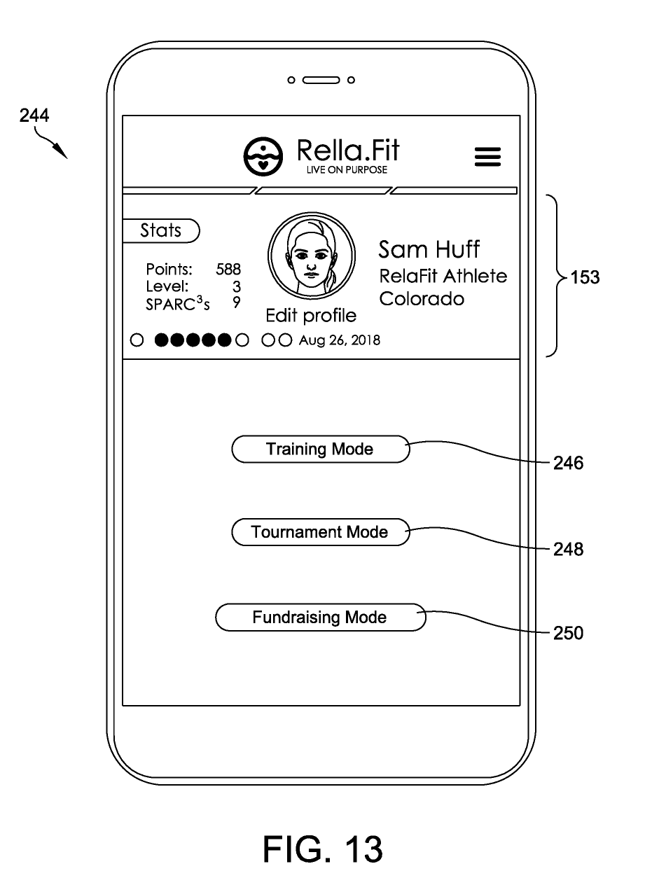

Again returning to the home screen 148 of FIG. 10A, the athlete 101 may select the go to modes button 166 to link to a modes screen 244, an embodiment of which is shown in FIG. 13. In this embodiment, the modes screen 244 may include buttons linking to a training mode 246, a tournament mode 248, and a fundraising mode 250. In this embodiment, the software 120 may be selectively operated in these three modes in addition to the base daily SPARC³ mode discussed above in relation to FIGS. 11A-11B.

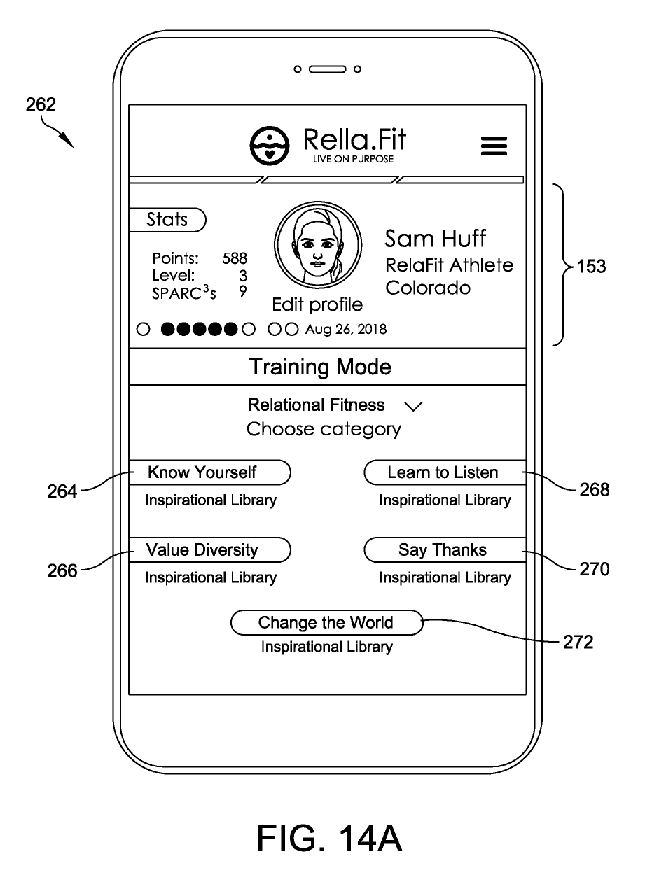

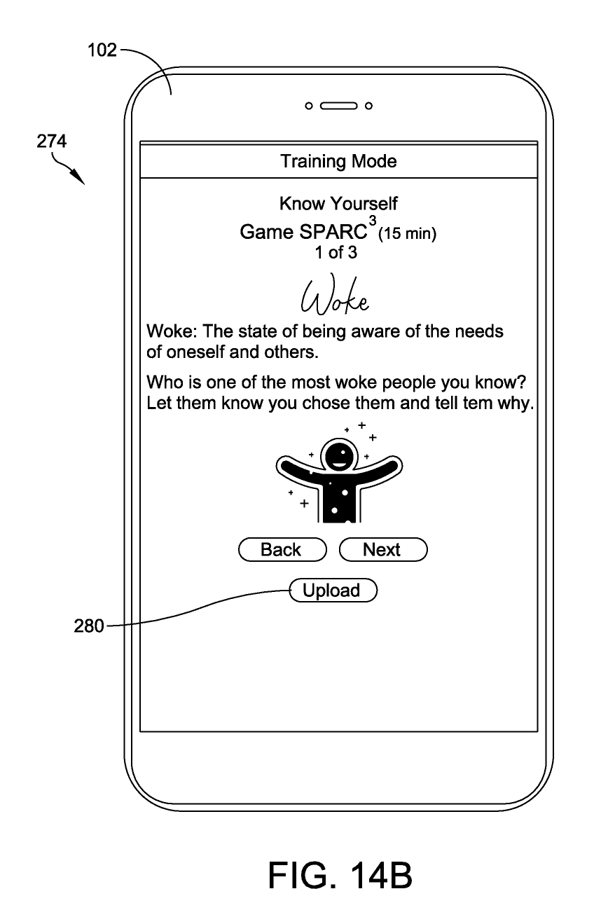

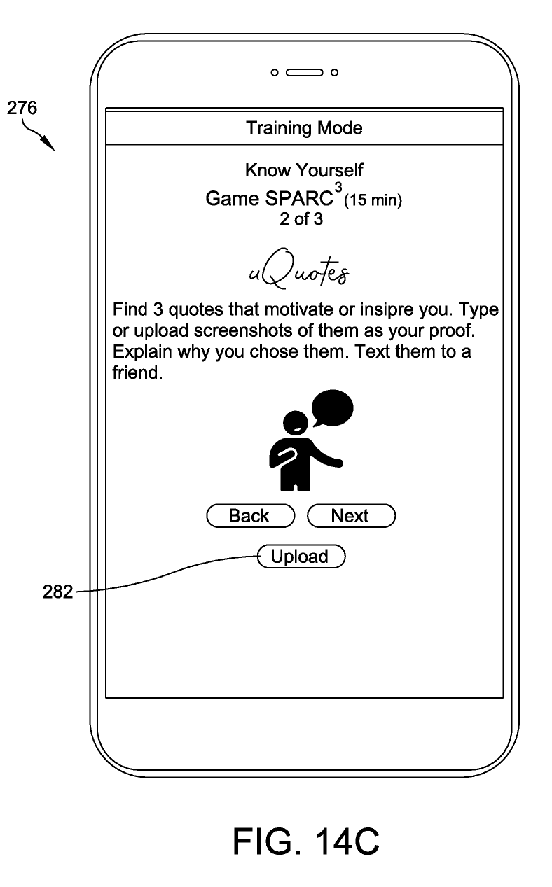

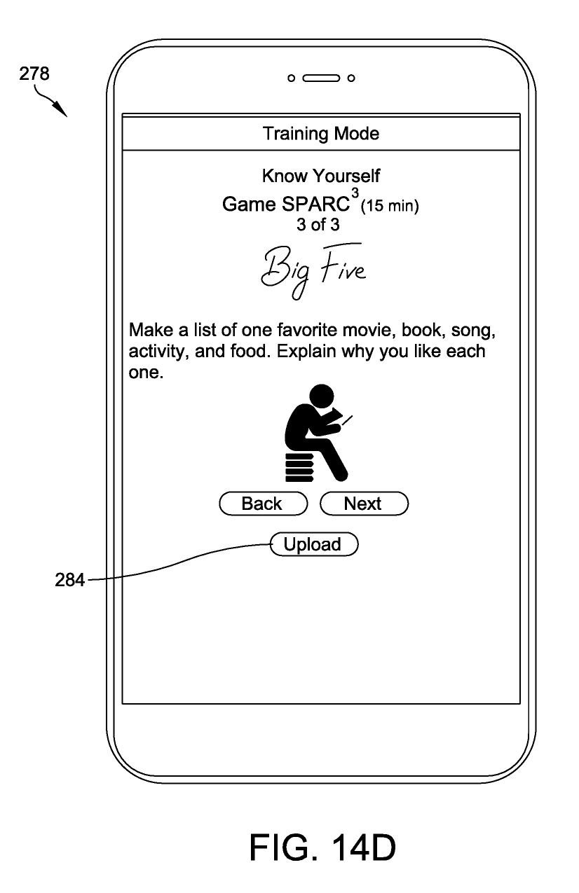

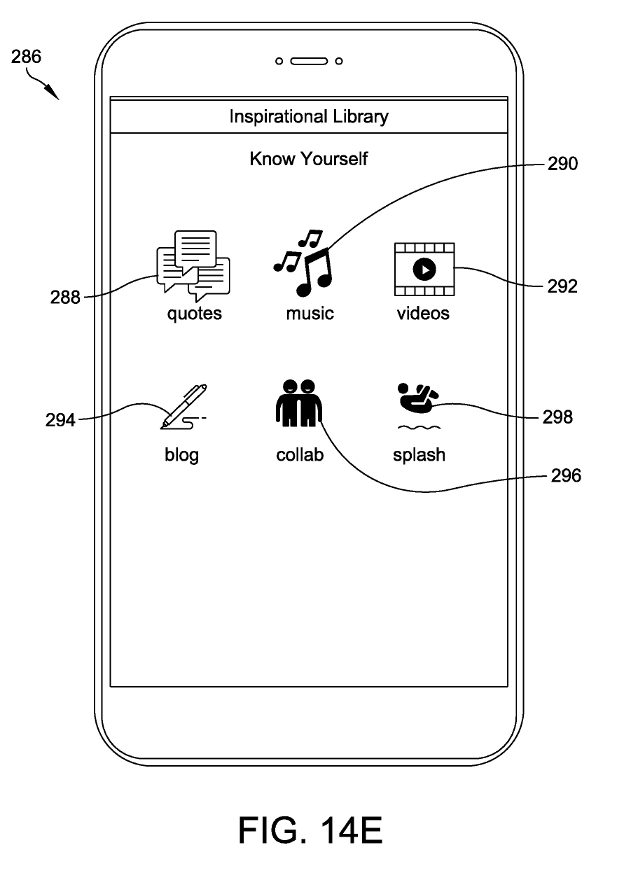

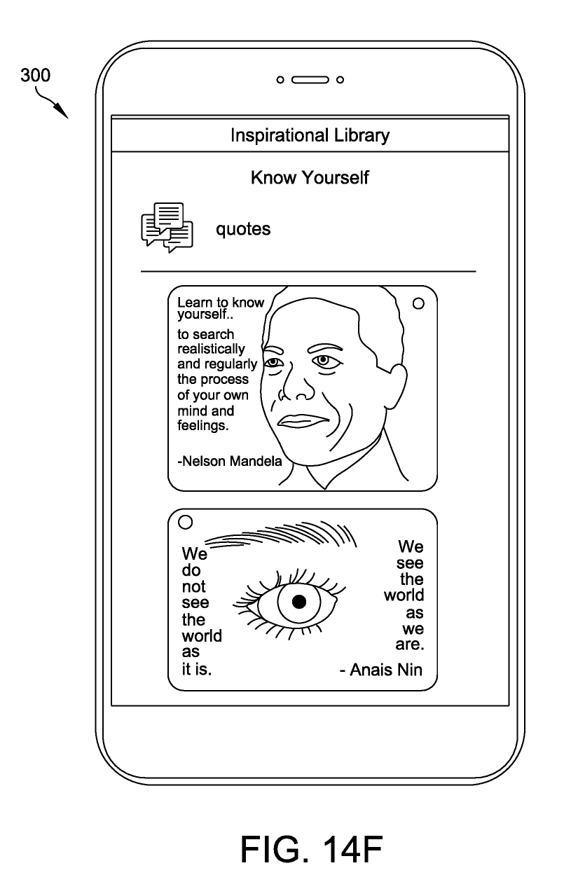

FIGS. 14A-14F illustrate exemplary interactive and preconfigured GUI screens that may be presented when the training mode button 246 is selected and the software 120 operates in the training mode. In one embodiment, a relational fitness training mode screen 262 may provide a plurality of training content module buttons. For example, and as shown in FIG. 14A, the training mode screen 262 may present a know yourself button 264, a value diversity button 266, a learn to listen button 268, a say thanks button 270, and a change the world button 272. The training mode may provide any type and/or variety of training modules as is desired and/or appropriate for the training of relational fitness abilities in a variety of categories. For example, other exemplary training modules may include faith in action, leadership, physical fitness, and so on. The number and type of training modules available to the user athlete 101 via the training mode screen 262 may be based on the user athlete's subscription as represented in the athlete user's payor code provided upon signup or thereafter, or on modules the user athlete has paid to access.

Each of the training content modules may be associated with a related category of training challenge activities, or SPARC³s, for completion by the user athlete 101. For example, upon selection of the know yourself content module button 264, a category SPARC³ screen may open and provide the user athlete 101 with access to a plurality of category SPARC³s associated with the know yourself content module 264. FIGS. 14B-14D provide three exemplary category SPARC³ screens 274, 276, 278, associated with the know yourself content module 264. Each of the category SPARC³s may allow a different time period for completion (e.g., 5, 10, 15, 30 minutes to 1 hour+), and each of the category SPARC³ screens 274, 276, 278 may include an upload button 280, 282, 284, respectively, that directs the user athlete 101 to the proof screen 176 of FIG. 11C, which enables the user athlete 101 to upload proof of completion of the training category SPARC³ to be awarded points.

In addition to the SPARC³s associated with each of the Relational Fitness training content modules, each of the content modules may be associated with an inspirational library. For example, FIG. 14E provides one embodiment of an inspirational library screen 286 associated with the know yourself content module 264. From the inspirational library screen 286, the user athlete 101 may select from a number of inspiration or educational categories to link to an associated library of training content. Such inspiration libraries may be accessible through, for example, a quotes button 288, a music button 290, a videos button 292, a blog button 294, a collaboration button 296, and a splash button 298. Each of the inspiration category buttons may link to an inspirational screen that presents inspirational content associated with the selected relational fitness training content category/module. For example, the quotes button 288 on the inspirational library screen 286 for the know yourself content module 264 may link to a quotes screen 300 that presents inspirational quotes that fall within the know yourself training content category, as shown in FIG. 14F.

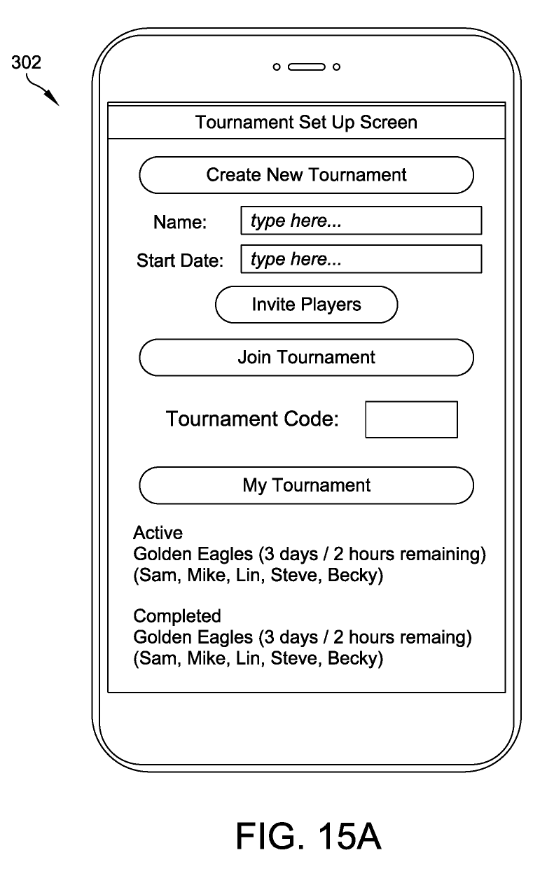

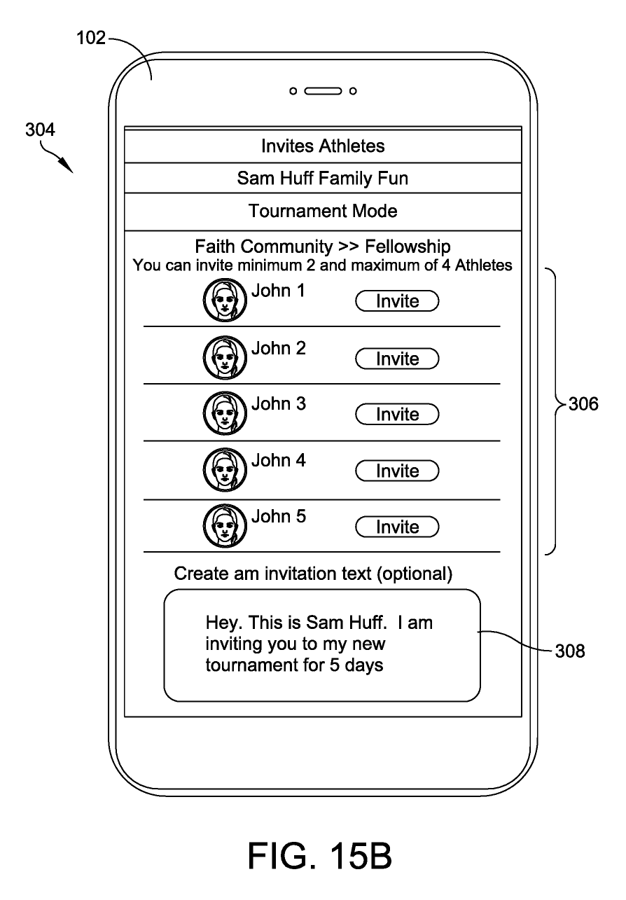

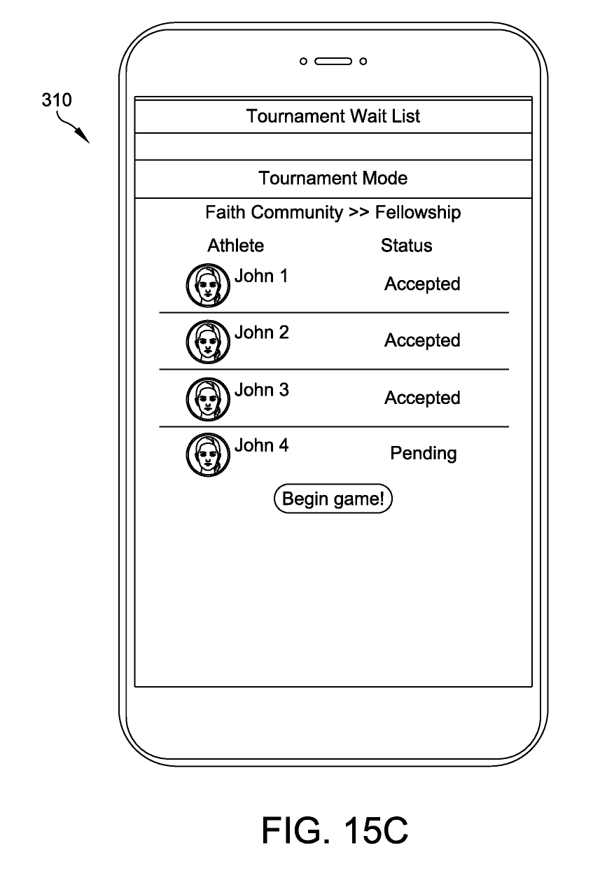

Returning to the modes screen 244 of FIG. 13, the user may select the tournament mode button 248 to link a tournament mode screen 302 shown in FIG. 15A. In tournament mode, individual athletes or groups/teams of athletes may compete for points resulting from SPARC³s completed over a defined tournament period of time. In this embodiment, the tournament mode screen 302 may present fields and/or buttons that allow the athlete 101 to create a new tournament, join an ongoing tournament, take action in a tournament that is currently underway, and/or view a history of tournaments the athlete 101 has previously participated in.

FIG. 15B provides one embodiment of a tournament invitation screen 304, from which a tournament organizer may invite other user athletes 101 to join a competitive tournament. The invitation screen 304 may be narrowed to select from one of the organizing athlete's groups (e.g., faith community/fellowship group) and may include a number of invite buttons 306 along with an invitation text field 308 within which the organizer may explain the tournament invite. When any one of the invite buttons 306 are selected, a tournament invitation is sent to the potential athlete player. When a new tournament is created, a code may be generated and passed to other athletes wishing to join the existing tournament. FIG. 15C provides an exemplary tournament player screen 310, which shows a status of the tournament invitations.

Tournaments may be structured in any appropriate and/or desired manner, as defined by the tournament organizer via the tournament mode screen 302. By way of limited example, a tournament may be structured to last three days between individual user athletes 101 identified as players, with the winning player being the user athlete 101 to accrue the most points through the completion of SPARC³ challenges over the tournament period. In another embodiment, each athlete player may be given 100 points during the tournament that they may award to other players. Any unawarded points may be distributed equally amongst the players at the end of the tournament period.

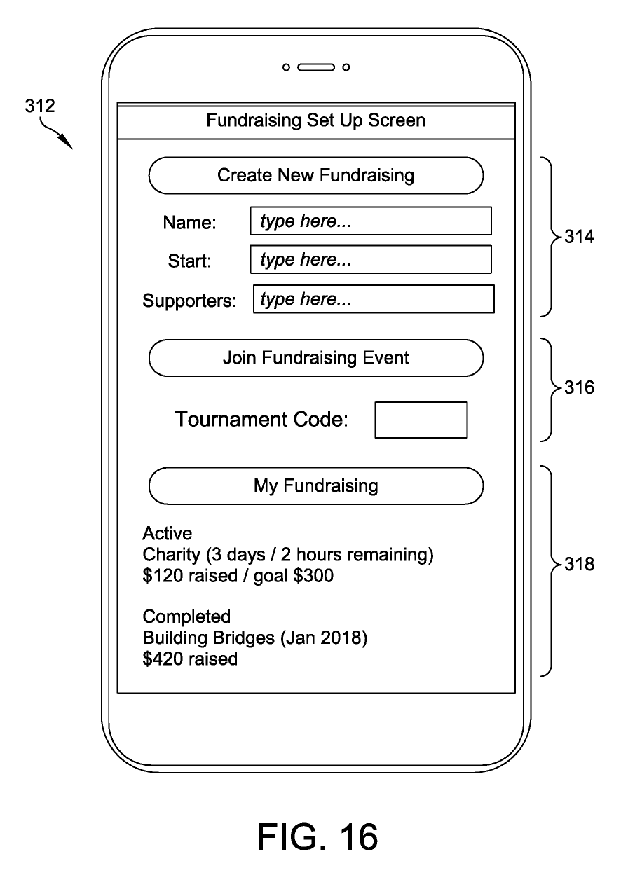

Again returning to the modes screen 244 of FIG. 13, the user may select the fundraising mode button 250 to be directed to a fundraising mode screen 312, as shown in FIG. 16. In fundraising mode, the software 120 may operate to connect supporters 103 with fundraising events during which the athlete 101 or a group of athletes 101 completes SPARC³s to receive pledged sponsorship/support dollars from the supporter(s) 103.

In one embodiment shown in FIG. 16, the fundraising mode screen 312 may include a create new fundraising event field 314, a join fundraising event field 316, and a my fundraising event field 318. Using these fields, the athlete 101 may generate a new fundraising event, connect a supporter or supporters 103 with an existing fundraising event such as, for example, a tournament using an existing tournament code, enter an existing fundraising event that is currently underway, or review a history of completed fundraising events. The supporter 103 may accept a fundraising invitation from the athlete 101, enter a tournament code or a separate fundraising code that was independently provided in another manner (e.g., verbally or via text or email), or review fundraising events that are underway or completed.

In fundraising mode, an individual athlete 101 (or a group of athletes 101) may be sponsored to complete SPARC³ challenges as part of a fundraising event. As the SPARC³s are completed, the athlete 101 may load proof of completion to the proof screen 176 of FIG. 11C. The supporter 103 may view each proof of completion 176 and leave comments and/or encouragement in the athlete's feed 170 (FIGS. 10B-10C). Once the supporter 103 has verified completion of the SPARC³s via the proof of completion provided by the athlete 101, the supporter 103 may provide or approve a fundraising payment (e.g., credit card payment) based upon the completion of the SPARC³s. Alternatively, the supporter 103 may provide payment information when pledging to support the fundraising event, and proof of completion of the SPARC³s for the fundraising event may automatically trigger a fundraising charge/payment or trigger a request for funds transfer. The fundraising payment may then be transferred the fundraising beneficiary such as, for example, the athlete 101, a group of athletes 101, a charity or other organization associated with the fundraising event, and/or to the operator of the software 120.

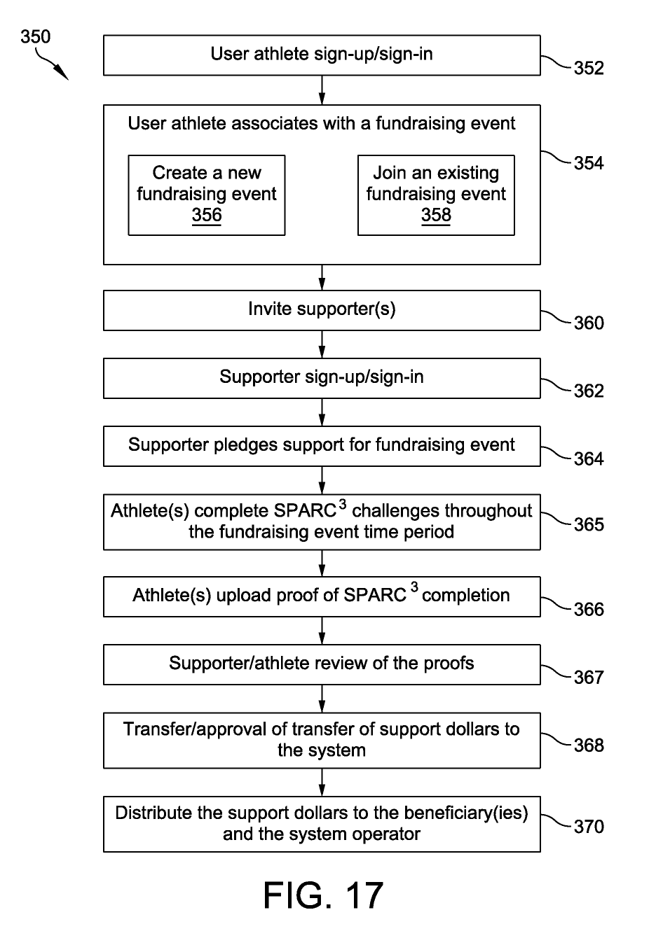

The various systems and components shown in FIGS. 4-16 may allow the execution of methods relating to the collaboration between user athletes 101 and supporters 103 for promoting wellness while fundraising support for a variety of causes. FIG. 17 provides a flowchart depicting and exemplary method (350) of fundraising using the integrated Relational Fitness development and fundraising tool and collaboration, reporting, and payment software discussed herein. In one embodiment, the method (350) initiates when an athlete 101 signs up with or signs into the system (352) and associates with a fundraising event (354) by creating a new fundraising event (356) or joining an existing fundraising event (358) via, for example, the fundraising mode screen 312. The fundraising event may be structured in any desired and/or appropriate manner. For example, the fundraising event may raise money for a beneficiary in exchange for the completion of SPARC³s within a fundraising event time period. The beneficiary of the fundraising dollars may be an individual (the individual athlete creating the event or another individual), a group, or an organization such as a designated charity organization. The event may be structured as a tournament to reward competing athletes or teams, as appropriate and/or desired.

Once the fundraising event is established or joined, the athlete 101 may invite one or more supporters 103 to pledge their support for the fundraising event (360) in the form of support dollars to be paid for points earned/SPARC³s completed. This supporter invitation (360) may occur during event setup via the create new fundraising event fields 314 of the fundraising mode screen 312 (FIG. 16) or at any time via the invite supporters screen 234 (FIG. 12F) accessible from the main menu 198. The supporter or supporters 103 may then sign up or sign into the system (362) and pledge their support for the event (364). The support pledge (364) may be structured in any appropriate manner that renders the support contingent, in some manner, on the completion of SPARC³s by the user athlete or athletes 101. In one example, a supporter 103 may pledge to pay the beneficiary a certain amount for each point earned by the user athlete 101 through the completion of SPARC³s throughout the fundraising event time period. In another example, the supporter 103 may pledge to pay a certain amount to the beneficiary on behalf of the athlete 103 who scores the most points in a tournament that forms the basis for the fundraising event.

Throughout the duration of the fundraising event, the athlete or athletes 103 may complete SPARC³ challenge activities (365) before uploading proof of completion of each SPARC³ challenge completed via the proof of completion screen 176 (366) for review by other athletes and the supporter(s) (367). Once the fundraising event time period is complete, the support dollars pledged by the supporter or supporters 103 may be transferred to the system (368). For example, once the fundraising event time period is complete, the supporter(s) 103 may be prompted to provide payment information (e.g., provide credit card or bank transfer information) to pay the support dollars pledged. Alternatively, if the supporter 101 previously supplied payment information (e.g., when initially pledging as a supporter), the supporter(s) 101 may be prompted to approve charges in order to complete their support pledge(s). This transfer of the support dollars (368) may be based upon each supporter's review of the proofs of completion loaded by the user athlete(s) 101. Once transferred to the system, the fundraising dollars are then automatically transferred to the fundraising beneficiary and, if applicable, the system operator (370).

In operation, the integrated Relational Fitness development and fundraising system and application provide a number of benefits over existing online and/or computerized personality profiling, self-improvement, and/or relationship-building tools and mechanisms. The system is mobile and adaptable in that content can be adapted to dozens of different environments and contexts (individual, family, after school program, course at a company, etc.) because it is written to appeal to a wide audience and it is partitioned into lessons, practices, and challenges of limited and approachable duration. Any links to outside content (e.g., TedTalks, podcasts, movies, music, etc.) are considered “deeper dives” for those who want to learn more or have additional practice. The system and application is also packaged as a game and presents content through a game format—points, tournaments, competition, etc.—which incentivizes participation and makes the concepts of self-awareness and improvement both engaging and fun. Further, many of the individual gaming elements are unique. For example, in tournament mode, a user may “give” points to other players based on how impressed the user is with the creativity or intensity of how the other user has completed their challenge.

The system and application is also interactive in that individuals are not merely profiled and informed of their personality “type.” Instead, sufficient information is provided to frame up an “action” that must be completed in order to receive points. In this regard, users must “do” something in real life to further their understanding of self, others, and the world around them and to solidify the positive behaviors associated with the four Relational Fitness abilities of see, accept, flow, and engage. In this regard, the system and application provide a technical mechanism through which users may receive content, track points, record accomplishments, and communicate/collaborate with other athletes. While other systems simply inform, the disclosed system and application informs and then trains users how to function more positively in their relationships by actively applying the knowledge gained through an understanding of their style profile. Users first learn, and then practice, which over time translates into improved relationships with self, others, and the world.

Further, the systems and method discussed above provide for an innovative and enhanced way to promote wellness through the practice of Relational Fitness abilities to increase a peaceful mind, meaningful work, and supportive tribe, while simultaneously coupling that practice with reliable, accountable fundraising initiatives through a single, monetized technological platform. Because the supporter(s) 103 (e.g., individual or corporate givers) have an opportunity view the uploaded proofs of SPARC³ challenge completion prior to the transfer of their support payment, the system provides a feedback loop that ensures accountability for challenge completion by the athlete(s), while promoting engagement and further pledging by the supporter(s) who are able to verify that the athletes have completed the promised challenges as part of the fundraiser, but are also able to interact with the athletes through the athlete feeds 170 over the duration of the fundraising event.

This technological structure improves upon existing online and other computerized platforms that separately address health, wellness, and fundraising and that fail to provide an accountability feedback loop for supporters' peace of mind. The platform directly connects user action to dollars raised, and makes the fundraising dollars dependent upon challenge completion. This improved system connects individuals, companies, charities, and communities through a positive and interactive computerized and online experience that brings out the best in each stakeholder. Company or corporate supporters 103 are provided a way to make a visible positive impact. Charities and other beneficiaries are provided an innovate way to raise money and connect with new donors, and communities are strengthened through the connective relationship between individuals and families, schools, and other societal organizations.

The disclosed system and application are also based on compelling content from a variety of fields such as psychology, philosophy, literature, art, poetry, and wisdom traditions, in addition to leveraging popular culture (TV shows, movies, and music) to make the application more compelling to the millennial generation and others.

A number of ancillary systems may be implemented in connection with or to enhance the integrated Relational Fitness development and fundraising system and methods discussed above. One system provides a card game tool for practicing Relational Fitness skills, as disclosed in U.S. Provisional Application No. 62/670,142, titled Relational Fitness Development System and Methods of Use, filed May 11, 2018 and incorporated herein by reference. Another system provides tool for facilitating interpersonal discovery and understanding one's relational style according to the style grid discussed above in relation to FIG. 3, as disclosed in U.S. Provisional Application No. 62/573,599, titled Systems and Method for Facilitating Personal Connections, filed Oct. 17, 2017 and incorporated herein by reference. Yet another system involves a computerized tool that enables a user to reveal their relational style and generate a personal relational style chart for the user, which may then be explored and examined through a plurality of tools that allow user athletes to compare their relational styles to others to gain awareness of similarities and differences, and to engage in a number of innovative activities that enable further exploration of the athlete's relational style. Such activities include guessing how other athlete's respond to questions in generating their own relational style charts, how other athletes rate or sort relational style questions, and selecting the most positive qualities that describe other athletes.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A system for fundraising based on a development of relational fitness skills, comprising:
a collaboration, reporting, and payment application accessible to a user athlete terminal and a supporter terminal, the collaboration, reporting, and payment application having a graphical user interface configured to interact with at least one user athlete and at least one user supporter and to access a collaboration, reporting, and payment server via a communication channel, the collaboration, reporting, and payment server having a non-transitory computer readable medium storing instructions for execution by a processor that accesses a storage system storing a challenge database, a user athlete database, a user supporter database, and a transaction database, the processor executing the instructions for:
providing, via the graphical user interface at the supporter terminal, an invitation to the user supporter to support a fundraising event comprising a plurality of challenge activities for completion by the user athlete over a fundraising event time period;
receiving, via the graphical user interface at the supporter terminal, a support pledge from the user supporter;
providing, via the graphical user interface at the user athlete terminal, the plurality of the challenge activities for completion by the user athlete;
receiving from the user athlete, via the graphical user interface at the user athlete terminal, a proof of completion for each of the plurality of the challenge activities completed by the user athlete; and
transferring, based on the proof of completion for each of the plurality of the challenge activities completed by the user athlete, the support pledge to a beneficiary of the fundraising event.

2. The system of claim 1, wherein the transferring the support pledge comprises one of:
transferring one or more support dollars from an account of the user supporter to the beneficiary; and
requesting approval from the user supporter to transfer the one or more of the support dollars from the account of the user supporter to the beneficiary.

3. The system of claim 1, wherein the receiving the proof of completion comprises one or more of receiving a text description for each of the plurality of the challenge activities completed by the user athlete, receiving a video showing each of the plurality of the challenge activities completed by the user athlete, and receiving an image showing each of the plurality of the challenge activities completed by the user athlete.

4. The system of claim 1, wherein the fundraising event comprises a competitive tournament between the user athlete and other user athletes in completing the plurality of the challenge activities.

5. The system of claim 1, wherein each of the plurality of the challenge activities requires the user athlete to practice one of a plurality of relational fitness abilities, wherein the plurality of the relational fitness abilities comprises seeing, accepting, flowing, and engaging with oneself, others, and the world.

6. The system of claim 1, wherein the beneficiary comprises one or more of the user athlete, a group of user athletes, an individual, a group of individuals, and a charity organization.

7. A method of practicing relational fitness abilities using a relational fitness development and fundraising tool comprising a server having a processor and a non-transitory memory, a storage system in communication with the processor and storing user athlete information, supporter information, and challenge activity information, and a collaboration, reporting, and payment application stored in the non-transitory memory for execution by the processor, the collaboration, reporting, and payment application comprising a rule module and a graphical user interface (GUI) module, the method comprising:
implementing a plurality of preconfigured and interactive GUI screens at a user athlete terminal and at a supporter terminal, the user athlete terminal and the supporter terminal in communication with the server via a network; and
selectively operating, via the plurality of the preconfigured and interactive GUI screens at the user athlete terminal and the supporter terminal, the collaboration, reporting, and payment application in one of a daily challenge mode involving a user athlete completing a daily challenge activity each day, a training mode involving the user athlete completing a plurality of training challenge activities that each relate to one of a plurality of relational fitness training content modules, a tournament mode involving the user athlete completing a plurality of tournament challenge activities in competition with other user athletes, and a fundraising mode involving the user athlete completing a plurality of fundraising challenge activities in exchange for a support pledge from a supporter at the supporter terminal.

8. The method of claim 7, wherein the selectively operating in the daily challenge mode comprises:
providing the daily challenge activity to the user athlete via a daily challenge screen at the user athlete terminal;
receiving, from the user athlete, a daily proof of completion of the daily challenge activity via a proof screen at the user athlete terminal; and
crediting the user athlete with one or more points in exchange for the daily proof of completion of the daily challenge activity.

9. The method of claim 7, wherein the selectively operating in the training mode comprises:
providing the plurality of the relational fitness training content modules to the user athlete via a training mode screen at the user athlete terminal, wherein each of the plurality of the relational fitness training content modules comprises a plurality of the training challenge activities for completion by the user athlete and an inspirational content library for review by the user athlete.

10. The method of claim 9, wherein the inspirational content library comprises at least an inspirational quotation library, a music library, a video library, and a blog.

11. The method of claim 7, wherein the selectively operating in the tournament mode comprises:
creating a competitive tournament via a tournament mode screen at the user athlete terminal;
providing the plurality of the tournament challenge activities to each of a plurality of tournament athletes for completion by the tournament athletes over a tournament period;
receiving from the plurality of the tournament athletes a tournament proof of completion for each of the tournament challenge activities completed by the plurality of the tournament athletes; and
crediting each of the plurality of the tournament athletes with one or more tournament points for each of the tournament proofs of completion received over the tournament period.

12. The method of claim 7, wherein the selectively operating in the fundraising mode comprises:
receiving, from the supporter via a first set of the preconfigured and interactive GUI screens at the supporter terminal, the support pledge to pay one or more support dollars in exchange for a completion of the plurality of the fundraising challenge activities by the user athlete;
providing, to the user athlete via a second set of the preconfigured and interactive GUI screens at the user athlete terminal, the plurality of the fundraising challenge activities for completion by the user athlete;
receiving, from the user athlete via a third set of the preconfigured and interactive GUI screens at the user athlete terminal, a proof of completion for each of the plurality of the fundraising challenge activities completed by the user athlete; and
transferring, from the supporter via a fourth set of the preconfigured and interactive GUI screens at the supporter terminal, the one or more of the support dollars to the beneficiary.

13. The method of claim 12, wherein the receiving the proof of completion comprises one or more of receiving a text description for each of the plurality of the fundraising challenge activities completed by the user athlete, receiving a video showing each of the plurality of the fundraising challenge activities completed by the user athlete, and receiving an image showing each of the plurality of the fundraising challenge activities completed by the user athlete.

14. The method of claim 12, wherein the transferring the one or more of the support dollars comprises one of:
receiving the one or more of the support dollars from the supporter and providing the one or more of the support dollars to the beneficiary; and
requesting approval from the supporter to transfer the one or more of the support dollars from an account of the supporter to the beneficiary.

15. The method of claim 14, wherein the beneficiary comprises one of the user athlete, a group of user athletes, an individual, a group of individuals, and a charity organization.

16. A computer-controlled system for raising funds for a beneficiary based upon a user athlete's completion of one or more challenge activities that promote relational fitness, comprising:
a server having a processor and a non-transitory memory;
a storage system in communication with the processor;
a collaboration, reporting, and payment application stored on the non-transitory memory, the collaboration, reporting, and payment application comprising a rule module and a graphical user interface (GUI) module, the processor accessing the storage system and executing the rule module and the GUI module for:
implementing a plurality of preconfigured and interactive GUI screens at a user athlete terminal and at a supporter terminal;
receiving, from a supporter via a first set of the preconfigured and interactive GUI screens at the supporter terminal, a pledge to pay one or more support dollars in exchange for a completion of one or more challenge activities by the user athlete during a fundraising event;
providing, to the user athlete via a second set of the preconfigured and interactive GUI screens at the user athlete terminal, the one or more of the challenge activities for completion by the user athlete;
receiving, from the user athlete via a third set of the preconfigured and interactive GUI screens at the user athlete terminal, a proof of completion for each of the one or more of the challenge activities completed by the user athlete; and
transferring, from the supporter via a fourth set of the preconfigured and interactive GUI screens at the supporter terminal and based on the proof of completion for each of the one or more of the challenge activities completed, the one or more of the support dollars to the beneficiary.

17. The computer-controlled system of claim 16, wherein the storage system comprises a challenge database, a user athlete database, a supporter database, and a transaction database.

18. The computer-controlled system of claim 16, wherein the transferring the one or more of the support dollars comprises one of:
receiving the one or more of the support dollars from the supporter and providing the one or more of the support dollars to the beneficiary; and
requesting approval from the supporter to transfer the one or more of the support dollars from an account of the supporter to the beneficiary.

19. The computer-controlled system of claim 18, wherein the beneficiary comprises one of the user athlete, a group of user athletes, an individual, a group of individuals, and a charity organization.

20. The computer-controlled system of claim 16, wherein the fundraising event comprises a competitive tournament between the user athlete and other user athletes in completing the one or more of the challenge activities.
